(19) United States
(12) Patent Application Publication
(10) Pub. No.: US 2025/0343613 A1
(43) Pub. Date: Nov. 6, 2025

(54) IDENTIFICATION DEVICE AND IDENTIFICATION METHOD

(71) Applicant: NIPPON TELEGRAPH AND TELEPHONE CORPORATION, Tokyo (JP)

(72) Inventors: Go YAZAWA, Tokyo (JP); Keisuke YAMAGATA, Tokyo (JP); Takashi NAKANISHI, Tokyo (JP); Shinichi YOSHIHARA, Tokyo (JP); Tomoaki YOSHIDA, Tokyo (JP)

(73) Assignee: NIPPON TELEGRAPH AND TELEPHONE CORPORATION, Tokyo (JP)

(21) Appl. No.: 18/866,541

(22) PCT Filed: May 17, 2022
(86) PCT No.: PCT/JP2022/020592

§ 371 Date: Nov. 17, 2024

(51) Int. Cl. H04J 3/06

(52) U.S. Cl. CPC H04J 3/0667

(57) ABSTRACT

An identification device (10) is an identification device that is connected to a first communication device and a second communication device that perform time synchronization, by transmission and reception of a time synchronization signal in accordance with a single profile among a plurality of profiles and identifies a profile used by at least the first communication device, of the first communication device and the second communication device, and the identification device includes identification units (12U and 12L) that identify a profile used by the first communication device, on the basis of information regarding the transmission and the reception of the time synchronization signal in accordance with the single profile among the plurality of profiles and a method of the time synchronization included in the time synchronization signal acquired from the first communication device.

### TECHNICAL FIELD

The present disclosure relates to an identification device and an identification method.

### BACKGROUND ART

The precision time protocol (PTP) has been known as one of methods for performing time synchronization between communication devices on a network (for example, refer to Non Patent Literature 1). In the PTP, a grand master clock (GMC) as an upper-level device and a Client as a lower-level device are connected via a network, and the Client synchronizes an in-device time with a reference time distributed from the GMC. Specifically, the GMC receives a global navigation satellite system (GNSS) signal and acquires the reference time. By transmitting and receiving a signal (time synchronization signal) between the GMC and the Client, the Client synchronizes the in-device time with the reference time distributed from the GMC.

The PTP includes a plurality of methods (profile) of which required parameters, time information formats, and the like are different from each other, in accordance with an industry, application, or the like where the PTP is used. In a case where the required profile is different for each Client, currently, as illustrated in FIG. 16, a different network is provided for each Client, and time synchronization by transmission and reception of the time synchronization signal between the GMC and the Client is performed for each network. On the other hand, in the future, as illustrated in FIG. 17, it is considered to perform time synchronization with the plurality of Clients via a single network, using the GMC that can cope with the plurality of profiles.

### CITATION LIST

### Non Patent Literature

Non Patent Literature 1: IEEE Standard for a Precision Clock Synchronization Protocol for Networked Measurement and Control Systems, IEEE Std 158-2019

### SUMMARY OF INVENTION

### Technical Problem

As illustrated in FIG. 17, in a case of coping with the plurality of profiles, it is required to identify a profile used by an opposing communication device opposing via a network.

In the PTP, a value of profileIdentifier is set as information for identifying each profile. Furthermore, in the PTP, an acquisition request for a profileIdentifier of the communication device and a mechanism of a response of the profileIdentifier to the acquisition request, using a management message are defined. By using such a mechanism, the profile used by the communication device can be identified. However, in the mechanism using the management message, whether or not to implement by each profile is optional or it is considered that future discussion is needed. Therefore, the mechanism using the management message is not necessarily implemented in all commercially available devices.

An object of the present disclosure made in consideration of the above problems is to provide an identification device and an identification method that can identify a profile used by a communication device, regardless of a device mounting situation.

### Solution to Problem

In order to solve the above problems, an identification device according to the present disclosure that is connected to a first communication device and a second communication device that perform time synchronization, by transmission and reception of a time synchronization signal in accordance with a single profile among a plurality of profiles and identifies a profile used by at least the first communication device, of the first communication device and the second communication device, the identification device includes the identification unit that identifies the profile used by the first communication device, on the basis of information regarding the transmission and the reception of the time synchronization signal in accordance with the single profile among the plurality of profiles and a method of the time synchronization, included in the time synchronization signal acquired from the first communication device.

Furthermore, in order to solve the above problems, an identification method by an identification device according to the present disclosure that is connected to a first communication device and a second communication device that perform time synchronization, by transmission and reception of a time synchronization signal in accordance with a single profile among a plurality of profiles and identifies a profile used by at least the first communication device of the first communication device and the second communication device, the identification method includes a step of acquiring the time synchronization signal from the first communication device and a step of identifying a profile used by the first communication device, on the basis of information regarding the transmission and the reception of the time synchronization signal in accordance with the single profile among the plurality of profiles and a method of the time synchronization, included in the acquired time synchronization signal.

### Advantageous Effects of Invention

According to an identification device and an identification method according to the present disclosure, it is possible to identify a profile used by a communication device, regardless of a device mounting situation.

### BRIEF DESCRIPTION OF DRAWINGS

FIG. 1A is a diagram for explaining time synchronization by a PTP (E2E), to which an identification device according to the present disclosure is applied.

FIG. 1B is a diagram for explaining time synchronization by a PTP (P2P), to which the identification device according to the present disclosure is applied.

FIG. 2 is a diagram illustrating a configuration example of a time synchronization system by the PTP, to which the identification device according to the present disclosure is applied.

FIG. 3A is a diagram illustrating a configuration example of an identification device according to a first embodiment of the present disclosure.

FIG. 3B is a diagram illustrating another configuration example of the identification device according to the first embodiment of the present disclosure.

FIG. 3C is a diagram illustrating still another configuration example of the identification device according to the first embodiment of the present disclosure.

FIG. 4 is a flowchart illustrating an example of an operation of the identification device illustrated in FIGS. 3A to 3C.

FIG. 5 is a diagram for explaining a plurality of profiles in the PTP.

FIG. 6 is a diagram illustrating an example of classification of the plurality of profiles.

FIG. 7A is a diagram illustrating an example of operations of a Master and a Client, in a case where a communication rate is adjusted between the Master and the Client, at the time of communication start in the PTP (E2E).

FIG. 7B is a diagram illustrating an example of operations of the Master and the Client, in a case where the communication rate is not adjusted between the Master and the Client, at the time of the communication start in the PTP (E2E).

FIG. 7C is a diagram illustrating another example of the operations of the Master and the Client, in a case where the communication rate is not adjusted between the Master and the Client, at the time of the communication start in the PTP (E2E).

FIG. 8A is a diagram illustrating an example of operations of the Master and the Client, in a case where the communication rate is adjusted between the Master and the Client, at the time of communication start in the PTP (P2P).

FIG. 8B is a diagram illustrating an example of operations of the Master and the Client, in a case where the communication rate is not adjusted between the Master and the Client, at the time of the communication start in the PTP (E2E).

FIG. 9A is a flowchart illustrating an example of an operation of an identification unit 12L in a case of L2/lower-level device/passive.

FIG. 9B is a flowchart illustrating an example of an operation of the identification unit 12L in a case of L3/lower-level device/passive.

FIG. 9C is a flowchart illustrating an example of an operation of an identification unit 12U in a case of L2/upper-level device/passive.

FIG. 9D is a flowchart illustrating an example of an operation of the identification unit 12U in a case of L3/upper-level device/passive.

FIG. 10A is a flowchart illustrating an example of an operation of the identification unit 12L in a case of L2/lower-level device/active.

FIG. 10B is a flowchart illustrating an example of an operation of the identification unit 12L in a case of L3/lower-level device/active.

FIG. 10C is a flowchart illustrating an example of an operation of the identification unit 12U in a case of L2/upper-level device/active.

FIG. 10D is a flowchart illustrating an example of an operation of the identification unit 12U in a case of L3/upper-level device/active.

FIG. 11 is a diagram illustrating a configuration example of an identification device according to a second embodiment of the present disclosure.

FIG. 12 is a diagram illustrating a configuration example of an identification device according to a third embodiment of the present disclosure.

FIG. 13 is a diagram illustrating a configuration example of an identification device according to a fourth embodiment of the present disclosure.

FIG. 14 is a diagram illustrating another configuration example of the identification device according to the fourth embodiment of the present disclosure.

FIG. 15 is a diagram illustrating an example of a hardware configuration of the identification device according to the present disclosure.

FIG. 16 is a diagram for explaining time synchronization by a current PTP.

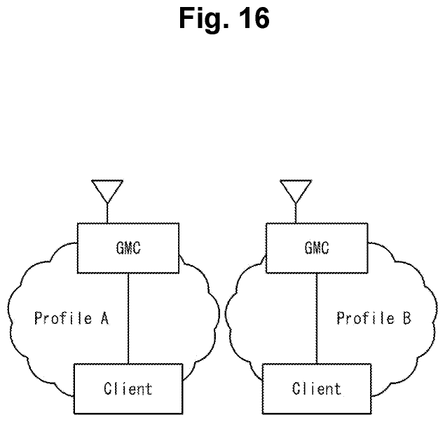

FIG. 17 is a diagram for explaining time synchronization by an expected PTP.

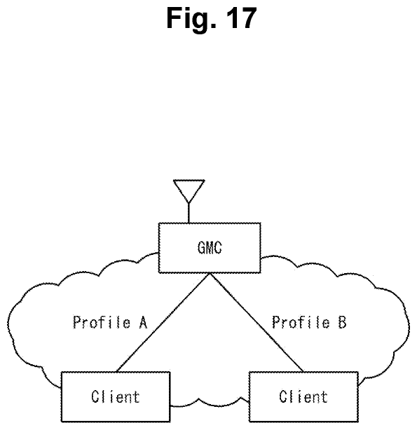

### DESCRIPTION OF EMBODIMENTS

Hereinafter, embodiments of the present disclosure will be described with reference to the drawings.

### First Embodiment

First, time synchronization by a PTP to which an identification device and an identification method according to the present disclosure are applied will be described. The time synchronization by the PTP includes an end-to-end (E2E) method and a peer-to-peer (P2P) method. Hereinafter, each of the time synchronization of the E2E method (PTP (E2E)) and the time synchronization of the P2P method (PTP (P2P)) is described.

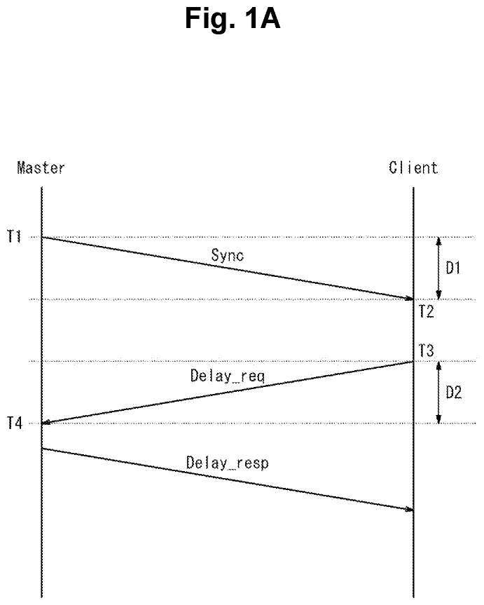

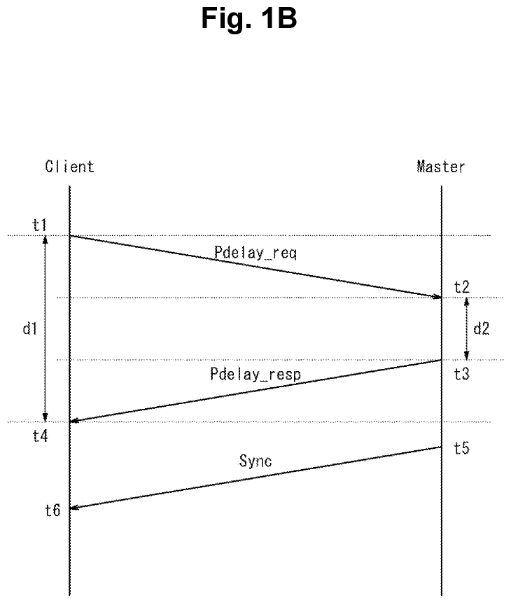

FIG. 1A is a diagram for explaining the time synchronization by the PTP (E2E).

As illustrated in FIG. 1A, in the PTP, the time synchronization is performed by transmission and reception of time synchronization signals between a Master as an upper-level device and a Client as a lower-level device. The Master has a function (Master function) for acquiring a reference time and distributing the acquired reference time to the lower-level device for synchronization. The Master is, for example, a GMC described above. The Client has a function (Client function) for synchronizing an in-device time with the reference time distributed from the Master.

At a time T1, the Master transmits a Sync message (hereinafter, simply referred to as “Sync”). The Master includes the time T1 that is a transmission time of the Sync in the Sync. As a result, the Client can grasp the time T1 when the Sync is transmitted by the Master. Upon receiving the Sync transmitted from the Master at a time T2, the Client transmits a Delay req message (hereinafter, simply referred to as “Delay req”) to the Master at a time T3. Upon receiving the Delay req at a time T4, the Master transmits a Delay resp message (hereinafter, simply referred to as “Delay resp”) to the Client. The Master includes the time T4 that is a reception time of the Delay req in the Delay resp. As a result, the Client can grasp the time T4 when the Delay req is received by the Master.

A transmission delay time from the Master to the Client is set to D1, a transmission delay time from the Client to the Master is set to D2, and a delay time between the Master and the Client is set to D. When D=D1=D2, the Client can calculate the delay time D in accordance with the following formula.

$$D = ( ( T 4 - T 3 ) + ( T 2 - T 1 ) / 2$$

The Client can calculate a time difference Δt between the Master and the Client in accordance with the following formula, on the basis of the calculated delay time D.

$$Δ t = T 2 - ( T 1 + D )$$

The Client can synchronize the in-device time with the reference time distributed from the Master, by correcting the in-device time on the basis of the calculated time difference Δt.

Next, time synchronization by the PTP (P2P) will be described.

FIG. 1B is a diagram for explaining the time synchronization by the PTP (P2P).

At a time t1, the Client transmits a Pdelay_req message (hereinafter, simply referred to as “Pdelay_req”). Upon receiving the Pdelay_req transmitted from the Client at a time t2, the Master transmits a Pdelay_resp message (hereinafter, simply referred to as “Pdelay_resp” to the Client at a time t3. The Master includes a difference (t3−t2) between the time t3 that is a transmission time of the Pdelay_resp and the time t2 that is a reception time of the Pdelay_req in the Pdelay_resp. The Client receives the Pdelay_resp at a time t4. After transmitting the Pdelay_resp, the Master transmits the Sync at a time t5. The Master includes the time t5 that is a transmission time of the Sync in the Sync. The Client receives the Sync transmitted from the Master at a time t6.

A response time from when the Client transmits the Pdelay_req to when the Client receives the Pdelay_resp is set to d1, and a response processing time from when the Master receives the Pdelay_req to when the Master receives the Pdelay_resp is set to d2 (=t3−t2). When D=D1=D2, the Client can calculate the delay time D in accordance with the following formula.

$$D = ( d 1 - d 2 ) / 2 = ( ( t 4 - t 1 ) - ( t 3 - t 2 ) ) / 2$$

The Client can calculate a time difference Δt between the Master and the Client in accordance with the following formula, on the basis of the calculated delay time D.

$$Δ t = t 6 - ( t 5 + D )$$

The Client can synchronize the in-device time with the reference time distributed from the Master, by correcting the in-device time on the basis of the calculated time difference Δt.

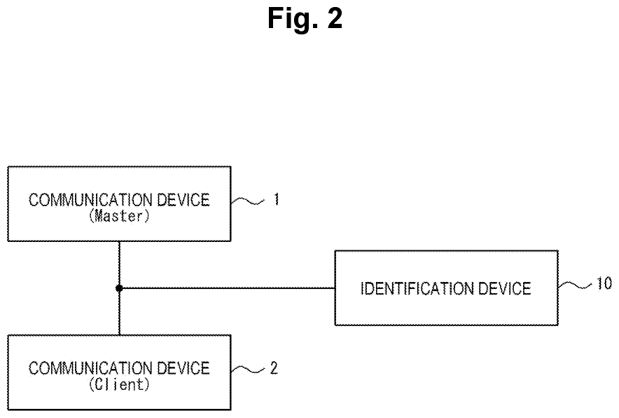

Next, an outline of an identification device 10 according to the present embodiment will be described with reference to FIG. 2. FIG. 2 is a diagram illustrating a configuration example of a time synchronization system by the PTP, to which the identification device 10 according to the present embodiment is applied. The identification device 10 illustrated in FIG. 2 identifies a profile used by at least one communication device (first communication device) of communication devices 1 and 2 (first and second communication devices) that are provided to face each other and perform time synchronization, by transmitting and receiving a time synchronization signal corresponding to a single profile among a plurality of profiles defined by the PTP.

In the time synchronization system illustrated in FIG. 2, the communication device 1 acquires a reference time and distributes the reference time to the communication device 2. Furthermore, the communication device 2 synchronizes an in-device time with the reference time distributed from the communication device 1. That is, in FIG. 2, the communication device 1 is an upper-level device that has a Master function, and the communication device 2 is a lower-level device that has a Client function. The identification device 10 according to the present embodiment identifies a profile used by at least one communication device (first communication device) of the communication devices 1 and 2.

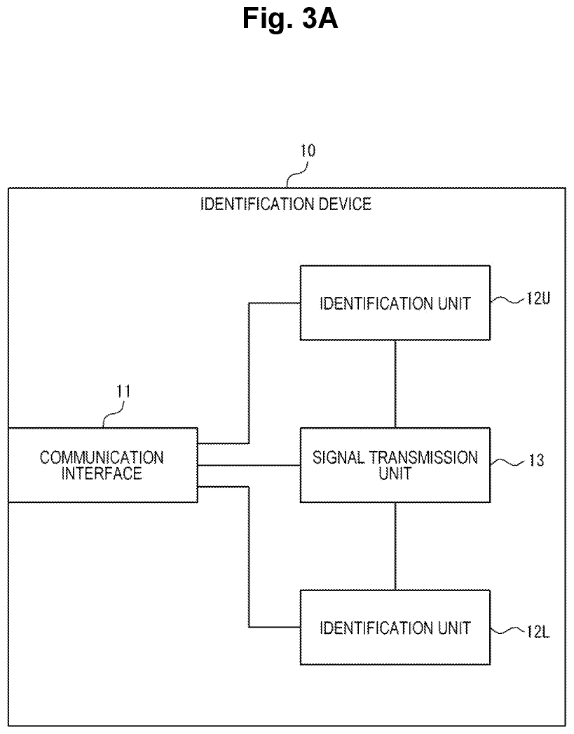

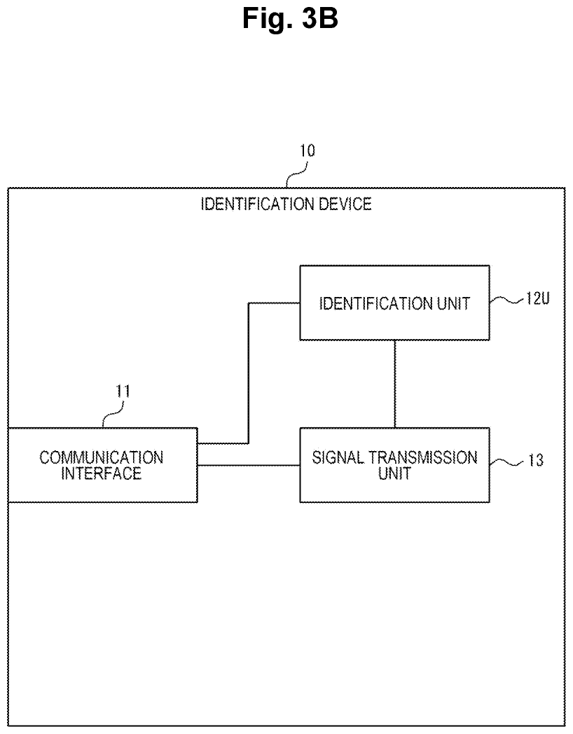

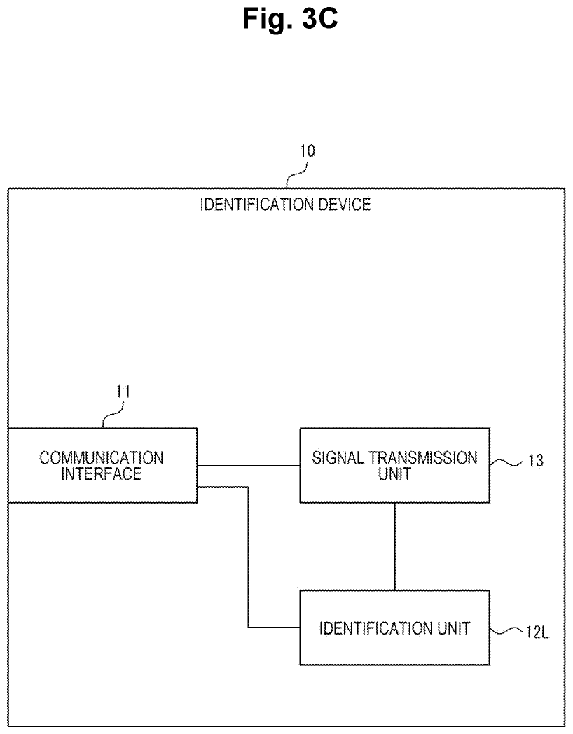

FIGS. 3A to 3C are diagrams illustrating configuration examples of the identification device 10 according to the present embodiment. FIG. 3A is a diagram illustrating a configuration example of the identification device 10 in a case where profiles used by the communication device 1 that is the upper-level device and the communication device 2 that is the lower-level device are identified. FIG. 3B is a diagram illustrating a configuration example of the identification device 10 in a case where the profile used by the communication device 1 that is the upper-level device is identified. FIG. 3C is a diagram illustrating a configuration example of the identification device 10 in a case where the profile used by the communication device 2 that is the lower-level device is identified.

As illustrated in FIG. 3A, the identification device 10 according to the present embodiment includes a communication interface 11, an identification unit 12U, an identification unit 12L, and a signal transmission unit 13.

The communication interface 11 acquires various signals (time synchronization signal) for time synchronization, transmitted and received between the communication devices 1 and 2 via a network. The communication interface 11 acquires the time synchronization signal, for example, by snooping the time synchronization signal transmitted and received between the communication devices 1 and 2. Furthermore, the communication interface 11 transmits the time synchronization signal output from the signal transmission unit 13 to be described later to the communication devices 1 and 2 and acquires the time synchronization signal transmitted from the communication devices 1 and 2 in response to the transmission of the time synchronization signal. The communication interface 11 outputs the acquired time synchronization signal to the identification unit 12U or the identification unit 12L. Specifically, the communication interface 11 outputs the time synchronization signal acquired from the communication device 1 that is the upper-level device to the identification unit 12U and outputs the time synchronization signal acquired from the communication device 2 that is the lower-level device to the identification unit 12L.

The identification unit 12U identifies the profile used by the communication device 1, on the basis of information included in the time synchronization signal acquired from the communication device 1 that is the upper-level device, via the communication interface 11. The profile used by the communication device 1 is a profile regarding transmission of the time synchronization signal in a direction from the communication device 1 toward the communication device 2. Here, the identification unit 12U identifies the profile, on the basis of information regarding the transmission and reception of the time synchronization signals respectively corresponding to the plurality of profiles and a time synchronization method, included in the time synchronization signal. Such information is information constantly included in the time synchronization signal transmitted and received between the Master and the Client, in order to perform the time synchronization, unlike profileIdentifier exchanged using a management message described above. By using such information, the identification unit 12U can identify the profile used by the communication device 1, regardless of whether or the device is mounted.

The identification unit 12L identifies the profile used by the communication device 2, on the basis of information included in the time synchronization signal acquired from the communication device 2 that is the lower-level device, via the communication interface 11. The profile used by the communication device 2 is a profile regarding transmission of the time synchronization signal in a direction from the communication device 2 toward the communication device 1. Here, the identification unit 12L identifies the profile, on the basis of information regarding the transmission and reception of the time synchronization signals respectively corresponding to the plurality of profiles and the time synchronization method, included in the time synchronization signal. Such information is information constantly included in the time synchronization signal transmitted and received between the Master and the Client, in order to perform the time synchronization, unlike profileIdentifier exchanged using a management message described above. By using such information, the identification unit 12L can identify the profile used by the communication device 2, regardless of whether or the device is mounted.

The signal transmission unit 13 transmits a time synchronization signal (first time synchronization signal) to the communication devices 1 and 2 via the communication interface 11, under control of the identification units 12U and 12L. The identification units 12U and 12L identify the profile used by the communication devices 1 and 2, on the basis of information included in the received time synchronization signal, by receiving a time synchronization signal (second time synchronization signal) transmitted from the communication devices 1 and 2 in response to the transmission of the time synchronization signal (first time synchronization signal) by the signal transmission unit 13.

Note that, in a case where the identification device 10 identifies only the profile used by the communication device 1 that is the upper-level device, as illustrated in FIG. 3B, it is sufficient that the identification device 10 include the communication interface 11, the identification unit 12U, and the signal transmission unit 13. That is, the identification device 10 does not need to include the identification unit 12L. Furthermore, in a case where the identification device 10 identifies only the profile used by the communication device 2 that is the lower-level device, as illustrated in FIG. 3C, it is sufficient that the identification device 10 include the communication interface 11, the identification unit 12L, and the signal transmission unit 13. That is, the identification device 10 does not need to include the identification unit 12U. Furthermore, in the present embodiment, the identification unit 12U that identifies the profile used by the communication device 1 that is the upper-level device and the identification unit 12L that identifies the profile used by the communication device 2 that is the lower-level device are separately described. However, the present embodiment is not limited to this. The identification device 10 may include a single identification unit that can identify profiles respectively used by the communication devices 1 and 2.

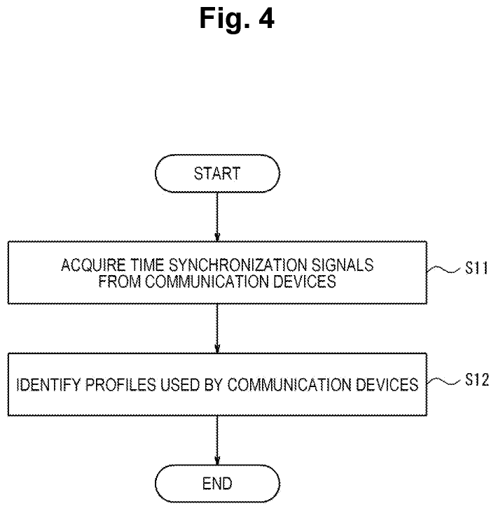

FIG. 4 is a flowchart illustrating an example of an operation of the identification device 10 according to the present embodiment and is a diagram for explaining a communication method by the identification device 10 according to the present embodiment.

The identification units 12U and 12L acquire the time synchronization signals from the communication devices 1 and 2, via the communication interface 11 (step S11). Although details will be described later, the identification units 12U and 12L passively or actively acquire the time synchronization signals from the communication devices 1 and 2.

The identification units 12U and 12L identify the profiles used by the communication devices 1 and 2, on the basis of the information regarding the transmission and the reception of the time synchronization signal in accordance with the single profile among the plurality of profiles and the time synchronization method, included in the acquired time synchronization signal (step S12).

The information regarding the transmission and the reception of the time synchronization signal in accordance with the profile and the time synchronization method is information constantly included in the time synchronization signal transmitted and received between the Master and the Client, in order to perform the time synchronization, unlike the profileIdentifier exchanged using the management message described above. By using such information, according to the communication method according to the present embodiment, it is possible to identify the profile used by the communication devices 1 and 2, regardless of whether or not the device is mounted.

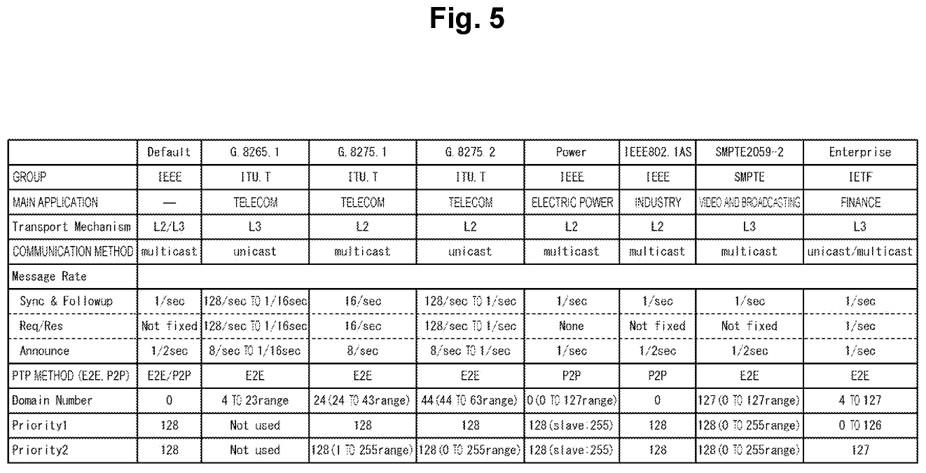

Next, details of the identification of the profile used by the communication devices 1 and 2, by the identification device 10 according to the present embodiment will be described. First, an example of the plurality of profiles to be candidates to be used by the communication devices 1 and 2 will be described with reference to FIG. 5.

For example, as illustrated in FIG. 5, the profile to be the candidate includes a default profile (Default profile) defined by IEEE1588-2008, a telecom profile (G.8265.1 profile, G.8275.1 profile, and G.8275.2 profile) customized for communication by the international telecommunication union telecommunication standardization sector (ITU-T), a power profile (Power profile) for controlling a smart grid or a power system, an industrial profile (IEEE802.1 AS profile) for automatic driving, a video profile (SMPTE2059-2 profile) used for internet protocol (IP) communication of videos, an enterprise profile for finance, or the like. Note that, in FIG. 5, in the SMPTE2059-2 profile, multicast is set as a communication method, and E2E is set as a PTP method. However, the SMPTE2059-2 profile is not limited to this, and unicast/E2E, unicast/P2P, or multicast/P2P may be set.

Hereinafter, the Default profile, the G.8275.1 profile, the G.8275.2 profile, the Power profile, the IEEE802.1 AS profile, and the SMPTE2059-2 profile are assumed as the profiles to be the candidates used by the communication devices 1 and 2. Furthermore, hereinafter, for simple description, the Default profile is referred to as “D”, the G.8275.1 profile is referred to as “T1”, the G.8275.2 profile is referred to as “T2”, the Power profile is referred to as “P”, the IEEE802.1 AS profile is referred to as “AS”, and the SMPTE2059-2 profile is referred to as “S”. An example will be described in which the profile used by the communication devices 1 and 2 is identified from among these six profiles.

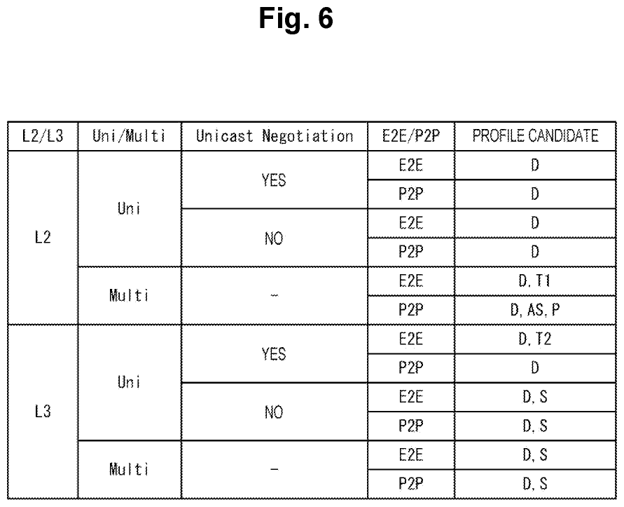

As illustrated in FIG. 6, the six profiles described above can be classified on the basis of whether a communication layer is L2 or L3 (L2/L3), whether a destination address of the time synchronization signal is a unicast address or a multicast address (Uni/Multi), whether or not a communication rate is adjusted between the communication devices 1 and 2 in a case where the destination address is the unicast address (whether or not unicast negotiation), and the time synchronization method (E2E/P2P). The identification unit 12 identifies the profile used by the communication devices 1 and 2 using such classification.

The information regarding the transmission and the reception of the time synchronization signal such as information indicating whether the destination address of the time synchronization signal is the unicast address or the multicast address and information indicating whether or not the communication rate is adjusted between the communication devices 1 and 2 is information that can be grasped from the time synchronization signals transmitted and received between the communication devices 1 and 2. Furthermore, the information regarding the time synchronization method such as whether the time synchronization method is the E2E or the P2P is information that can be grasped from the time synchronization signal transmitted and received between the communication devices 1 and 2. By using such information, according to the identification device 10 according to the present embodiment, it is possible to identify the profile used by the communication devices 1 and 2, regardless of whether or not the device is mounted.

Hereinafter, the identification of the profiles used by the communication devices 1 and 2 by the identification units 12U and 12L will be specifically described.

As described above, the identification device 10 may identify the profile used by the communication device 2 that is the lower-level device or may identify the profile used by the communication device 1 that is the upper-level device. Furthermore, operations of the communication devices 1 and 2 differ, in accordance with whether the PTP method is the E2E or the P2P or whether or not the communication rate is adjusted between the communication devices 1 and 2. As described above, the identification units 12U and 12L identify the profiles used by the communication devices 1 and 2, using the information included in the time synchronization signals transmitted and received between the communication devices 1 and 2. Here, the time synchronization signal used to identify the profiles by the identification units 12U and 12L differs depending on a profile identification target and the operations of the communication devices 1 and 2. Therefore, first, an example of the time synchronization signal used to identify the profile, depending on the profile identification target and the operations of the communication devices 1 and 2 will be described.

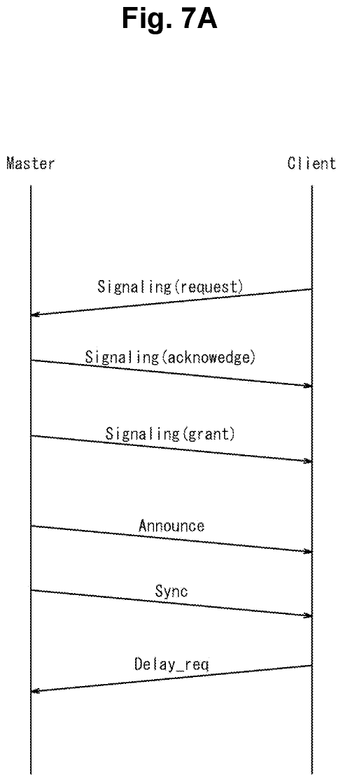

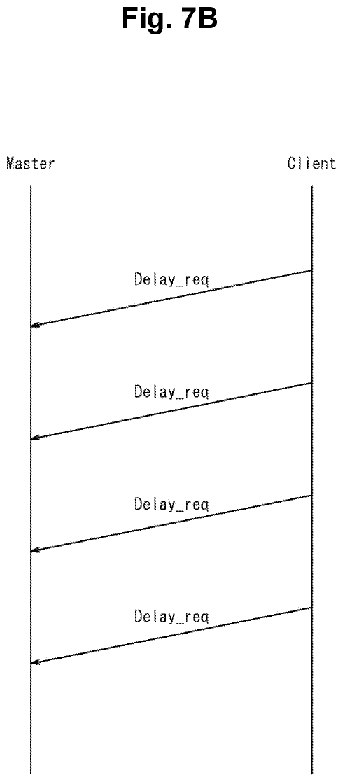

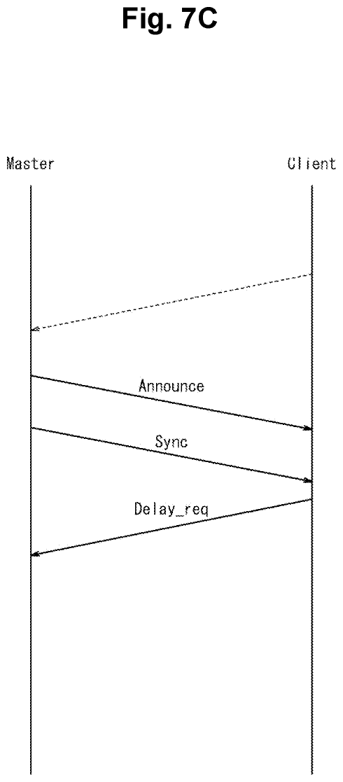

Each of FIGS. 7A, 7B, and 7C is a diagram illustrating an example of operations of the Master and the Client at the time of communication start in the PTP (E2E). FIG. 7A is a diagram illustrating an example of operations of the Master and the Client, in a case where the communication rate is adjusted between the Master and the Client. FIG. 7B is a diagram illustrating an example of operations of the Master and the Client, in a case where the communication rate is not adjusted between the Master and the Client (in a case where communication starts at preset communication rate). FIG. 7C is a diagram illustrating another example of the operations of the Master and the Client, in a case where the communication rate is not adjusted between the Master and the Client (in a case where communication starts at preset communication rate).

As illustrated in FIG. 7A, in a case where the communication rate is adjusted between the Master and the Client, the Client transmits a request (Signaling (request)) for adjusting the communication rate. The Master transmits an acknowledge (Signaling (acknowledge)) to the request from the Client and then, transmits an allocation communication permission (Signaling (grant)). Thereafter, the Master transmits Announce for notifying quality information such as time synchronization accuracy and then, transmits the Sync. The Client transmits the Delay req to the Master, in response to the Sync from the Master. The operation illustrated in FIG. 7A is an operation in a case where the unicast address is set as the destination address and there is unicast negotiation.

FIG. 7B illustrates a case where the Client autonomously starts communication. In this case, the Client transmits the Delay req to the Master. On the other hand, FIG. 7C illustrates a case where the Client does not autonomously start communication. In this case, the Master transmits an Announce message (hereinafter, simply referred to as “Announce”) and then, transmits the Sync. The Client transmits the Delay req to the Master, in response to the Sync from the Master. The operations illustrated in FIGS. 7B and 7C are operations in a case where the unicast address is set as the destination address and there is no unicast negotiation and in a case where the multicast address is set as the destination address.

In FIG. 7A, the identification unit 12L can identify the profile used by the communication device 2, using Signaling (request) that is the time synchronization signal transmitted first from the communication device 2 that is the Client.

In FIG. 7B, the identification unit 12L can identify the profile used by the communication device 2, using the Delay req that is the time synchronization signal transmitted first from the communication device 2 that is the Client.

In FIG. 7C, the time synchronization signal is not transmitted from the communication device 2 that is the Client. Therefore, the identification unit 12L can actively acquire the time synchronization signal from the communication device 2 and identify the profile used by the communication device 2, using the acquired time synchronization signal.

Furthermore, in FIG. 7A, the time synchronization signal is not transmitted from the communication device 1 that is the Master, unless the communication device 2 that is the Client transmits the Signaling. Therefore, the identification unit 12U can actively acquire the time synchronization signal from the communication device 1 and identify the profile used by the communication device 1, using the acquired time synchronization signal.

Furthermore, in FIG. 7C, the identification unit 12U can identify the profile used by the communication device 1, using the Announce or the Sync that is the time synchronization signal transmitted first from the communication device 1 that is the Master.

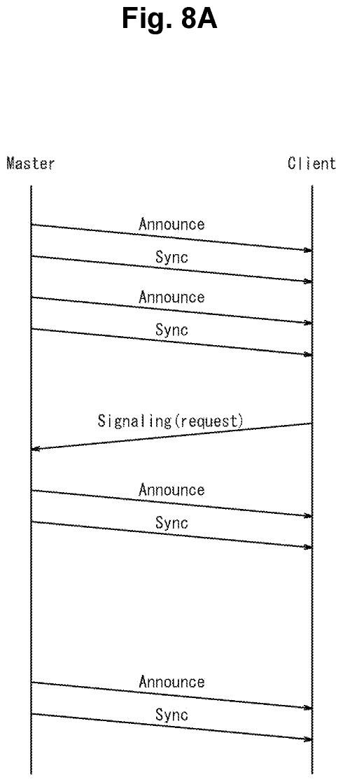

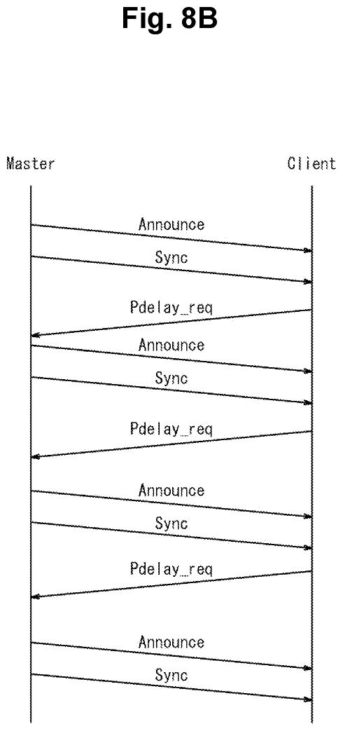

Each of FIGS. 8A and 8B is a diagram illustrating an example of operations of the Master and the Client at the time of communication start in the PTP (P2P). FIG. 8A is a diagram illustrating an example of operations of the Master and the Client, in a case where the communication rate is adjusted in response to a request from the Client after the communication starts between the Master and the Client. FIG. 8B is a diagram illustrating an example of operations of the Master and the Client, in a case where communication is continued at a preset communication rate after the communication starts between the Master and the Client.

As illustrated in FIG. 8A, the Master transmits the Announce and then, transmits the Sync. Although illustration is omitted in FIG. 8A for simplification of the drawing, upon receiving the Announce and the Sync, the Client transmits the Pdelay_req to the Master. As a result, the communication starts between the Master and the Client. After the communication starts, when a communication rate change request (Signaling (request)) is transmitted from the Client, the communication rate is changed in response to the change request. On the other hand, in a case where the communication rate is not changed, as illustrated in FIG. 8B, the transmission of the Announce and the Sync by the Master and the transmission of the Pdelay_req by the Client are repeated.

In FIG. 8A, the identification unit 12L can identify the profile used by the communication device 2, using Signaling (request) that is the time synchronization signal transmitted first from the communication device 2 that is the Client.

In FIG. 8B, the identification unit 12L can identify the profile used by the communication device 2, using the Pdelay_req that is the time synchronization signal transmitted first from the communication device 2 that is the Client.

Furthermore, in FIGS. 8A and 8B, the identification unit 12U can identify the profile used by the communication device 1, using the Announce or the Sync that is the time synchronization signal received first from the communication device 1 that is the Master.

Hereinafter, a specific operation for identifying the profiles by the identification units 12U and 12L will be divided and described as each of cases whether the communication layer is L2 or L3, whether the profile identification target is the upper-level device (communication device 1) or the lower-level device (communication device 2), and whether the identification device 10 actively or passively acquires the time synchronization signal used to identify the profile. Note that, to passively acquire the time synchronization signal is to receive the time synchronization signal transmitted from the communication devices 1 and 2 by the identification device 10 without an action from the identification device 10. On the other hand, to actively acquire the time synchronization signal is to transmit the time synchronization signal (first time synchronization signal) to the communication devices 1 and 2 by the identification device 10 and to receive the time synchronization signal (second time synchronization signal) transmitted from the communication devices 1 and 2 in response to the time synchronization signal by the identification device 10.

Furthermore, hereinafter, a combination of the communication layer, the profile identification target, and how to acquire the time synchronization signal (passive or active) is described as “communication layer/profile identification target/passive or active”, for simple description. For example, in a case where the communication layer is the L2, the profile identification target is the lower-level device, and the identification device 10 passively acquires the time synchronization signal used to identify the profile, this is described as “L2/lower-level device/passive”.

### <In a Case of L2/Lower-Level Device/Passive>

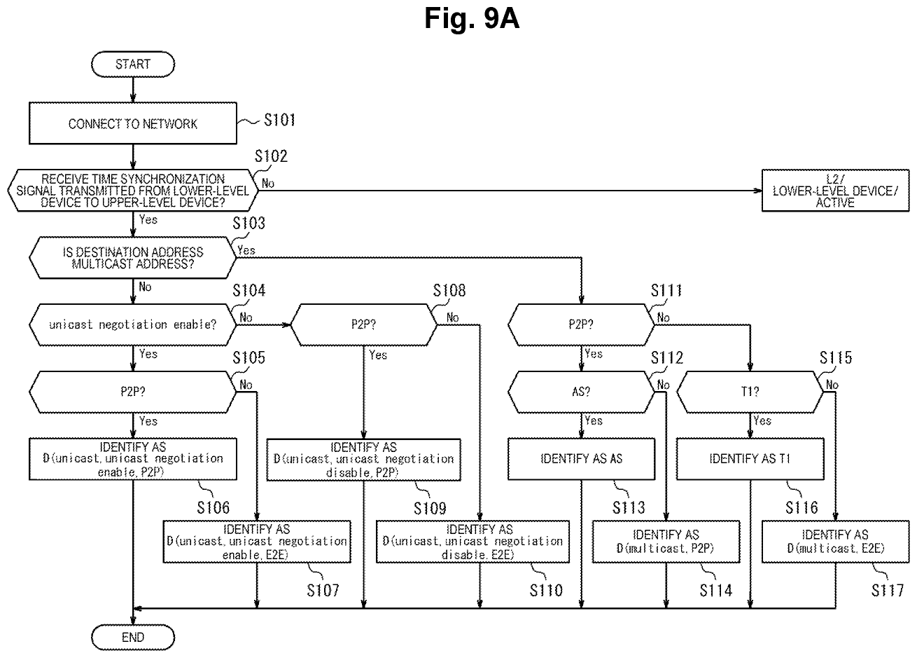

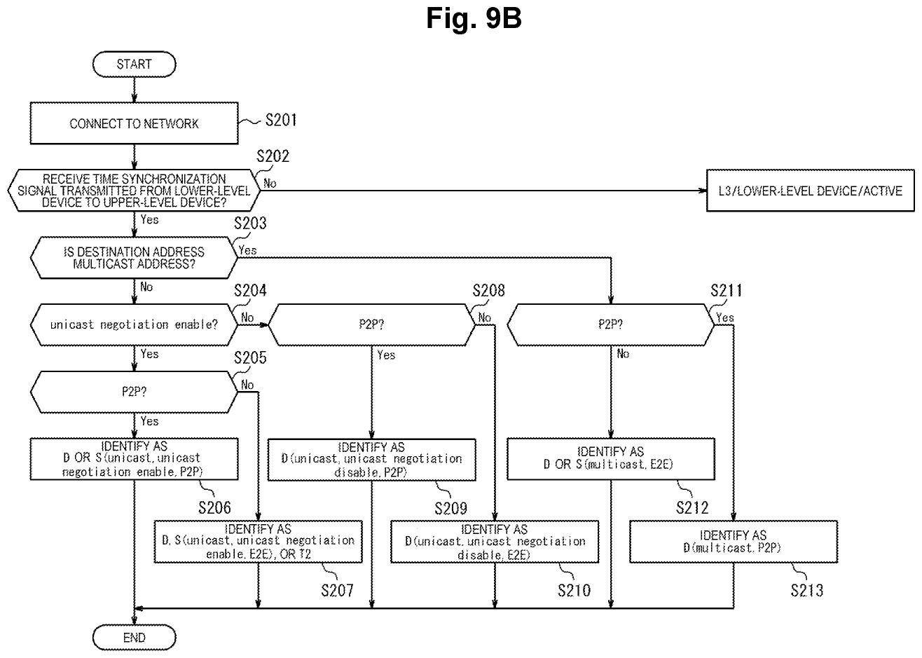

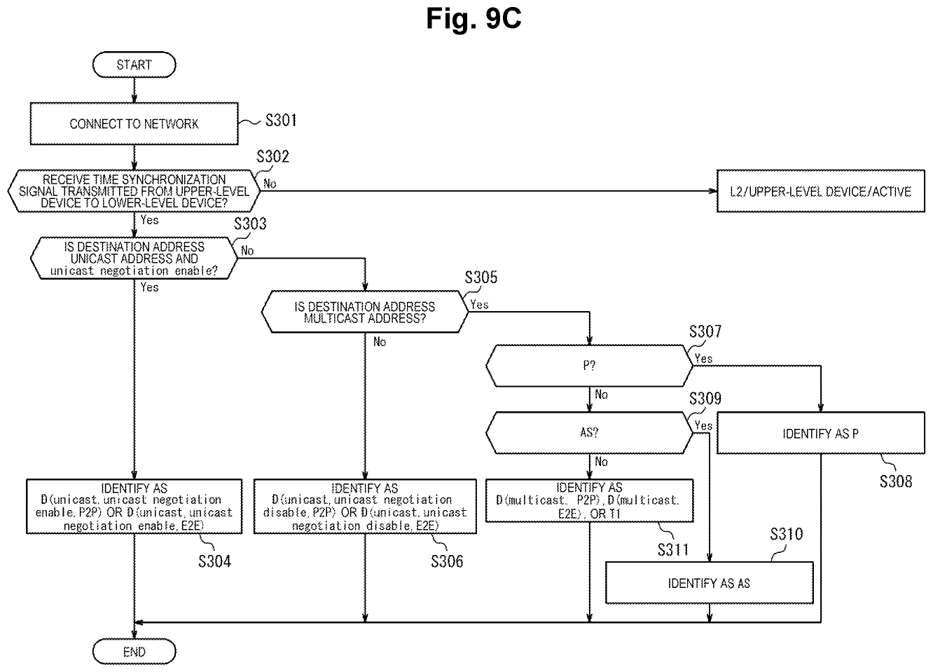

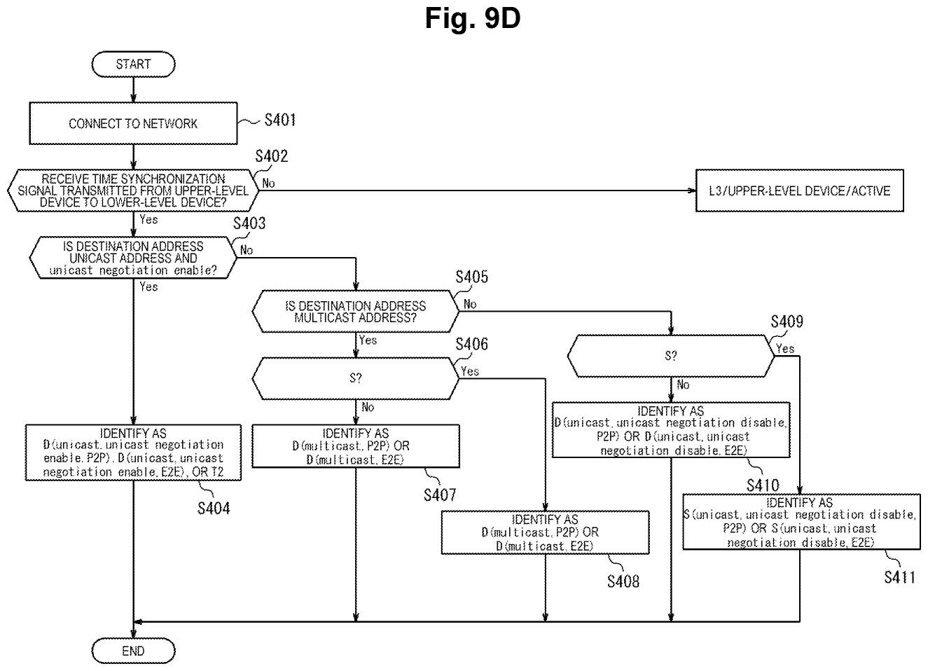

FIG. 9A is a flowchart illustrating an example of an operation of the identification unit 12L in a case of L2/lower-level device/passive. A target profile to be identified in FIG. 9A is D (unicast (unicast negotiation enable/disable)/multicast, E2E/P2P), T1, A, P.

The identification unit 12L connects to a network in which communication between the communication devices 1 and 2 in the L2 is performed (step S101). Note that, in the present embodiment, it is assumed that the identification device 10 have already known in which one of the L2 or the L3 the communication devices 1 and 2 perform communication.

The identification unit 12L determines whether or not the time synchronization signal transmitted from the lower-level device to the upper-level device via the communication interface 11 (for example, Signaling illustrated in FIG. 7A or Delay req illustrated in FIG. 7B, but not limited to these) (step S102).

In a case of determining that the time synchronization signal transmitted from the lower-level device to the upper-level device is not received (step S102: No), the identification unit 12L proceeds to processing in a case of L2/lower-level device/active to be described later.

In a case of determining that the time synchronization signal is received from the lower-level device to the upper-level device (step S102: Yes), the identification unit 12L determines whether or not the destination address of the received time synchronization signal is the multicast address (step S103).

In a case of determining that the destination address of the time synchronization signal is not the multicast address (destination address is unicast address) (step S103: No), the identification unit 12L determines whether or not it is unicast negotiation enable (whether or not there is unicast negotiation) (step S104).

Specifically, the identification unit 12L determines whether or not a time synchronization signal including REQUESTUNICAST_TRANSMISSION TLV is received. In a case where the time synchronization signal including the REQUESTUNICAST_TRANSMISSION TLV is received, the identification unit 12L determines that it is unicast negotiation enable. Furthermore, in a case where the time synchronization signal including REQUESTUNICAST_TRANSMISSION TLV is not received, the identification unit 12L determines that it is unicast negotiation disable.

In a case of determining that it is unicast negotiation enable (step S104: Yes), the identification unit 12L determines whether or not the time synchronization method is the P2P (step S105). Specifically, the identification unit 12L determines whether or not a message Type of REQUESTUNICAST_TRANSMISSION TLV included in the received time synchronization signal includes the Pdelay_resp. In a case of determining that the message Type of REQUESTUNICAST_TRANSMISSION TLV includes the Pdelay_resp, the identification unit 12L determines that the time synchronization method is the P2P. Furthermore, in a case of determining that the message Type of REQUESTUNICAST_TRANSMISSION TLV does not include the Pdelay_resp (include Delay resp), the identification unit 12L determines that the time synchronization method is the E2E.

In a case of determining that the time synchronization method is the P2P (step S105: Yes), the identification unit 12L identifies that a profile used by the lower-level device is D (unicast, unicast negotiation enable, P2P) (step S106), and ends the processing.

In a case of determining that the time synchronization method is not the P2P (is E2E) (step S105: No), the identification unit 12L identifies that the profile used by the lower-level device is D (unicast, unicast negotiation enable, E2E) (step S107), and ends the processing.

In a case of determining that it is not unicast negotiation enable (step S104: No), the identification unit 12L determines whether or not the time synchronization method is the P2P (step S108). Specifically, the identification unit 12L determines whether or not a Pdelay_request message is received from the lower-level device. In a case of determining that the Pdelay_request message is received, the identification unit 12L determines that the time synchronization method is the P2P. Furthermore, in a case of determining that the Pdelay_request message is not received, the identification unit 12L determines that the time synchronization method is the E2E.

In a case of determining that the time synchronization method is the P2P (step S108: Yes), the identification unit 12L identifies that the profile used by the lower-level device is D (unicast, unicast negotiation disable, P2P) (step S109), and ends the processing.

In a case of determining that the time synchronization method is not the P2P (is E2E) (step S108: No), the identification unit 12L identifies that the profile used by the lower-level device is D (unicast, unicast negotiation disable, E2E) (step S110), and ends the processing.

In a case of determining that the destination address of the time synchronization signal is the multicast address (step S103: Yes), the identification unit 12L determines whether or not the time synchronization method is the P2P (step S111). The identification unit 12L determines whether or not the time synchronization method is the P2P by processing similar to step S108.

In a case of determining that the time synchronization method is the P2P (step S111: Yes), the identification unit 12L determines whether or not the profile used by the lower-level device is AS (step S112). Specifically, the identification unit 12L determines whether or not the time synchronization signal received from the lower-level device includes a Message interval request or gPTP-capable TLV.

In a case of determining that the time synchronization signal includes the Message interval request or the gPTP-capable TLV (step S112: Yes), the identification unit 12L identifies that the profile used by the lower-level device is AS (step S113), and ends the processing.

In a case of determining that the time synchronization signal does not include the Message interval request and the gPTP-capable TLV (step S112: No), the identification unit 12L identifies that the profile used by the lower-level device is D (multicast, P2P) (step S114), and ends the processing.

In a case of determining that the time synchronization method is not the P2P (is E2E) (step S111: No), the identification unit 12L determines whether or not the profile used by the lower-level device is T1 (step S115). Specifically, the identification unit 12L determines whether or not the time synchronization signal received from the lower-level device includes a Delay request message and a reception interval thereof is less than one second.

In a case of determining that the time synchronization signal includes the Delay request message and the reception interval thereof is less than one second (step S115: Yes), the identification unit 12L identifies that the profile used by the lower-level device is T1 (step S116), and ends the processing.

In a case of determining that the time synchronization signal does not include the Delay request message or the reception interval thereof is equal to or longer than one second even if the Delay request message is included (step S115: No), the identification unit 12L identifies that the profile used by the lower-level device is D (multicast, E2E) (step S117), and ends the processing.

### <In a Case of L3/Lower-Level Device/Passive>

FIG. 9B is a flowchart illustrating an example of an operation of the identification unit 12L in a case of L3/lower-level device/passive. A target profile to be identified in FIG. 9B is D (unicast (unicast negotiation enable/disable)/multicast, E2E/P2P), T2 (unicast, unicast negotiation enable, E2E), and S (unicast (unicast negotiation disable)/multicast, E2E/P2P).

The identification unit 12L connects to a network in which communication between the communication devices 1 and 2 in the L3 is performed (step S201).

The identification unit 12L determines whether or not the time synchronization signal transmitted from the lower-level device to the upper-level device via the communication interface 11 (for example, Signaling illustrated in FIG. 7A or Delay req illustrated in FIG. 7B, but not limited to these) is received (step S202).

In a case of determining that the time synchronization signal transmitted from the lower-level device to the upper-level device is not received (step S202: No), the identification unit 12L proceeds to processing in a case of L3/lower-level device/active to be described later.

In a case of determining that the time synchronization signal transmitted from the lower-level device to the upper-level device is received (step S202: Yes), the identification unit 12L determines whether or not a destination address of the received time synchronization signal is the multicast address (step S203).

In a case of determining that the destination address of the time synchronization signal is not the multicast address (destination address is unicast address) (step S203: No), the identification unit 12L determines whether or not it is unicast negotiation enable (whether or not there is unicast negotiation) (step S204). The identification unit 12L determines whether or not it is unicast negotiation enable, for example, by processing similar to step S104.

In a case of determining that it is unicast negotiation enable (step S204: Yes), the identification unit 12L determines whether or not the time synchronization method is the P2P (step S205). The identification unit 12L determines whether or not the time synchronization method is the P2P, for example, by processing similar to step S105.

In a case determining that the time synchronization method is the P2P (step S205: Yes), the identification unit 12L identifies that the profile used by the lower-level device is D or S (unicast, unicast negotiation enable, P2P) (step S206), and ends the processing.

In a case of determining that the time synchronization method is not the P2P (is E2E) (step S205: No), the identification unit 12L identifies that the profile used by the lower-level device is D, S (unicast, unicast negotiation enable, E2E), or T2 (step S207), and ends the processing.

In a case of determining that it is not unicast negotiation enable (step S204: No), the identification unit 12L determines whether or not the time synchronization method is the P2P (step S208). The identification unit 12L determines whether or not the time synchronization method is the P2P by processing similar to step S108.

In a case of determining that the time synchronization method is the P2P (step S208: Yes), the identification unit 12L identifies that the profile used by the lower-level device is D (unicast, unicast negotiation disable, P2P) (step S209), and ends the processing.

In a case of determining that the time synchronization method is not the P2P (is E2E) (step S208: No), the identification unit 12L identifies that the profile used by the lower-level device is D (unicast, unicast negotiation disable, E2E) (step S210), and ends the processing.

In a case of determining that the destination address of the time synchronization signal is the multicast address (step S203: Yes), the identification unit 12L determines whether or not the time synchronization method by the PTP is the P2P (step S211). The identification unit 12L determines whether or not the time synchronization method is the P2P by processing similar to step S208.

In a case of determining that the time synchronization method is not the P2P (is E2E) (step S211: No), the identification unit 12L identifies that the profile used by the lower-level device is D or S (multicast, E2E) (step S212), and ends the processing.

In a case of determining that the time synchronization method is the P2P (step S211: Yes), the identification unit 12L identifies that the profile used by the lower-level device is D or S (multicast, P2P) (step S213), and ends the processing.

In FIG. 9B, in steps S206, S212, and S213, it is not possible to identify whether the profile used by the lower-level device is D or S. Furthermore, in FIG. 9B, in step S207, it is not possible to identify whether the profile used by the lower-level device is D, S, or T2. However, in a case where the identification device 10 actively acquires the time synchronization signal as described later, by combining a method for identifying whether or not the profile used by the lower-level device is S, the identification unit 12L can identify whether or not the profile used by the lower-level device is S.

### <In a Case of L2/Upper-Level Device/Passive>

FIG. 9C is a flowchart illustrating an example of an operation of the identification unit 12U in a case of L2/upper-level device/passive. A target profile to be identified in FIG. 9C is D (unicast (unicast negotiation enable/disable)/multicast, E2E/P2P), T1 (multicast, E2E), A (multicast, E2E), and P (multicast, E2E).

The identification unit 12U connects to a network in which communication between the communication devices 1 and 2 in the L2 is performed (step S301).

The identification unit 12U determines whether or not the time synchronization signal transmitted from the upper-level device to the lower-level device via the communication interface 11 is received (step S302).

In a case of determining that the time synchronization signal transmitted from the upper-level device to the lower-level device is not received (step S302: No), the identification unit 12U proceeds to processing in a case of L2/upper-level device/active to be described later.

In a case of determining that the time synchronization signal transmitted from the upper-level device to the lower-level device is received (step S302: Yes), the identification unit 12U determines whether or not a destination address of the received time synchronization signal is the unicast address and it is unicast negotiation enable (step S303).

In a case of determining that the destination address of the time synchronization signal is the unicast address and it is unicast negotiation enable (step S303: Yes), the identification unit 12U identifies that the profile used by the upper-level device is D (unicast, unicast negotiation enable, P2P) or D (unicast, unicast negotiation enable, E2E) (step S304), and ends the processing.

In a case of determining that the destination address of the time synchronization signal is the multicast address or it is unicast negotiation disable although the destination address of the time synchronization signal is the unicast address (step S303: No), the identification unit 12U determines whether or not the destination address of the time synchronization signal is the multicast address (step S305).

In a case of determining that the destination address is not the multicast address (step S305: No), the identification unit 12U identifies that the profile used by the upper-level device is D (unicast, unicast negotiation disable, P2P) or D (unicast, unicast negotiation disable, E2E) (step S306), and ends the processing.

In a case of determining that the destination address is the multicast address (step S305: Yes), the identification unit 12U determines whether or not the profile used by the upper-level device is P (step S307). Specifically, the identification unit 12U determines whether or not the Announce transmitted from the upper-level device includes IEEE_C37_238 TLV.

In a case of determining that the Announce includes IEEE_C37_238 TLV (step S307: Yes), the identification unit 12U identifies that the profile used by the upper-level device is P (step S308), and ends the processing.

In a case of determining that the Announce does not include IEEE_C37_238 TLV (step S307: No), the identification unit 12U determines whether or not the profile used by the upper-level device is AS (step S309). Specifically, the identification unit 12U determines whether or not organizationId receives follow up message including Follow Up information TLV of 00-80-C2, from the upper-level device. The follow up message is a time synchronization signal transmitted from the upper-level device in a case where information that cannot be transmitted by the Sync is complemented in AS.

In a case of determining that the organizationId receives the follow up message including Follow Up information TLV of 00-80-C2 (step S309: Yes), the identification unit 12U identifies that the profile used by the upper-level device is AS (step S310), and ends the processing.

In a case of determining that the organizationId does not receive the follow up message including Follow Up information TLV of 00-80-C2 (step S309: No), the identification unit 12U identifies that the profile used by the upper-level device is D (multicast, P2P), D (multicast, E2E), or T1 (step S311), and ends the processing.

### <In a Case of L3/Upper-Level Device/Passive>

FIG. 9D is a flowchart illustrating an example of an operation of the identification unit 12U in a case of L3/upper-level device/passive. A target profile to be identified in FIG. 9D is D (unicast (unicast negotiation enable/disable)/multicast, E2E/P2P), T2 (unicast, unicast negotiation enable, E2E), and S (unicast (unicast negotiation disable)/multicast, E2E/P2P).

The identification unit 12U connects to a network in which communication between the communication devices 1 and 2 in the L3 is performed (step S401).

The identification unit 12U determines whether or not the time synchronization signal transmitted from the upper-level device to the lower-level device via the communication interface 11 is received (step S402).

In a case of determining that the time synchronization signal transmitted from the upper-level device to the lower-level device is not received (step S402: No), the identification unit 12U proceeds to processing in a case of L3/upper-level device/active to be described later.

In a case of determining that the time synchronization signal transmitted from the upper-level device to the lower-level device is received (step S402: Yes), the identification unit 12U determines whether or not a destination address of the received time synchronization signal is the unicast address and it is unicast negotiation enable (step S403).

In a case of determining that the destination address of the time synchronization signal is the unicast address and it is unicast negotiation enable (step S403: Yes), the identification unit 12U identifies that the profile used by the upper-level device is D (unicast, unicast negotiation enable, P2P), D (unicast, unicast negotiation enable, E2E), or T2 (step S404), and ends the processing.

In a case of determining that the destination address of the time synchronization signal is the multicast address or it is unicast negotiation disable although the destination address of the time synchronization signal is the unicast address (step S403: No), the identification unit 12U determines whether or not the destination address of the time synchronization signal is the multicast address (step S405).

In a case of determining that the destination address is the multicast address (step S405: Yes), the identification unit 12U determines whether or not the profile used by the upper-level device is S (step S406). Specifically, the identification unit 12U determines whether or not a management message including Synchronization Metadata TLV is received from the upper-level device. In SMPTE, the management message is transmitted from the upper-level device in order to transmit profile specific information separately from the Announce.

In a case of determining that the management message including Synchronization Metadata TLV is not received (step S406: No), the identification unit 12U identifies that the profile used by the upper-level device is D (multicast, P2P) or D (multicast, E2E) (step S407), and ends the processing.

In a case of determining that the management message including Synchronization Metadata TLV is received (step S406: Yes), the identification unit 12U identifies that the profile used by the upper-level device is S (multicast, P2P) or S (multicast, E2E) (step S408), and ends the processing.

In a case of determining that the destination address is not the multicast address (step S405: No), the identification unit 12U determines whether or not the profile used by the upper-level device is S (step S409). The identification unit 12U determines whether or not the profile used by the upper-level device is S, by processing similar to step S406.

In a case of determining that the management message including Synchronization Metadata TLV is not received (step S409: No), the identification unit 12U identifies that the profile used by the upper-level device is D (unicast, unicast negotiation disable, P2P) or D (unicast, unicast negotiation disable, E2E) (step S410), and ends the processing.

In a case of determining that the management message including Synchronization Metadata TLV is received (step S406: Yes), the identification unit 12U identifies that the profile used by the upper-level device is S (unicast, unicast negotiation disable, P2P) or S (unicast, unicast negotiation disable, E2E) (step S411), and ends the processing.

### <In a Case of L2/Lower-Level Device/Active>

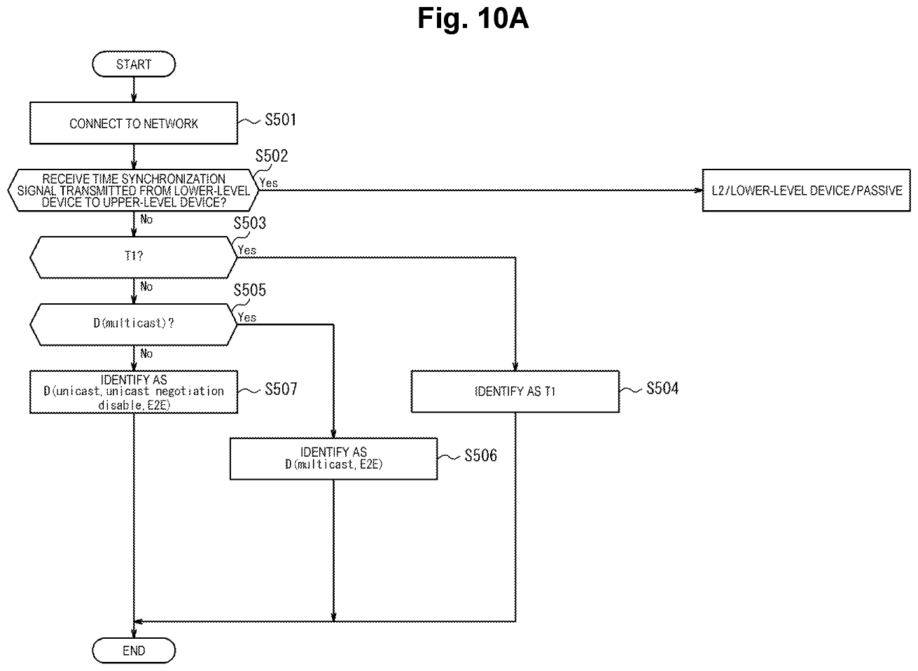

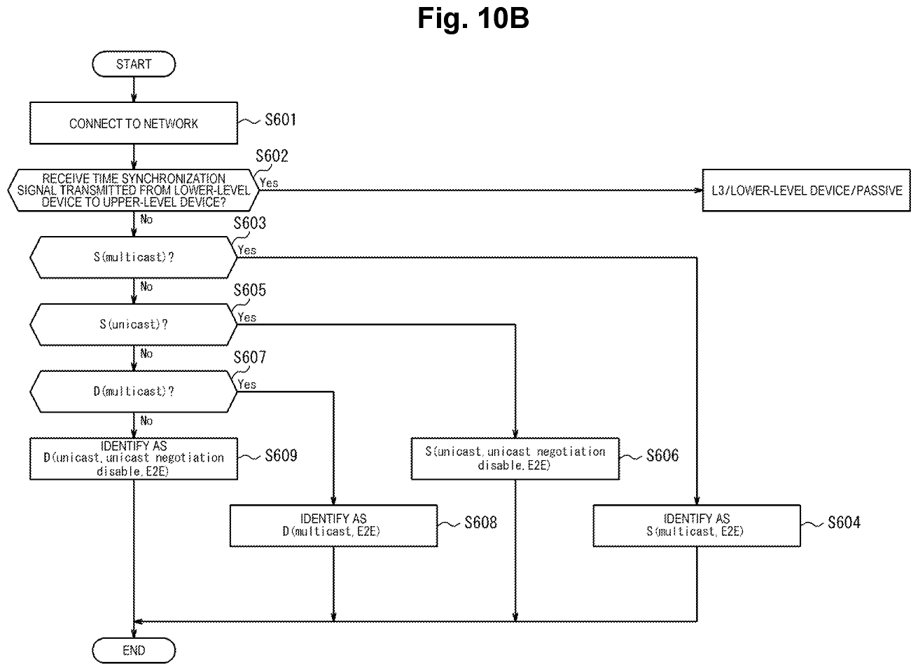

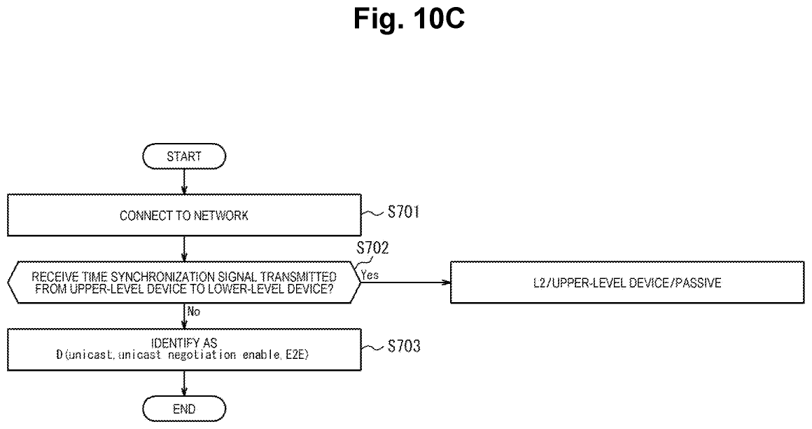

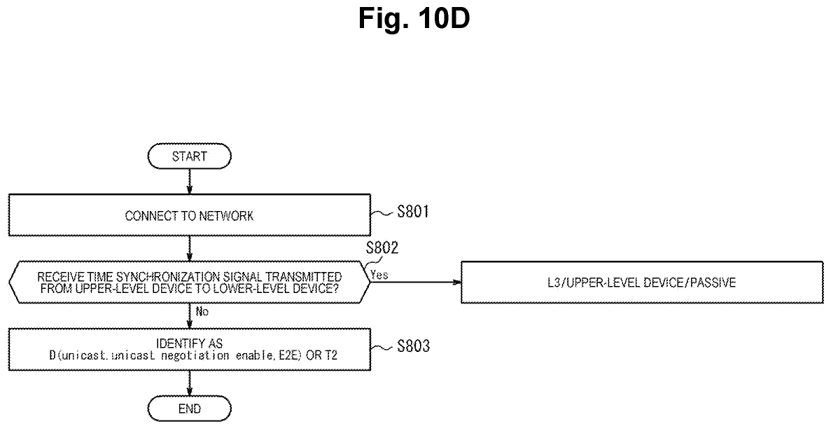

FIG. 10A is a flowchart illustrating an example of an operation of the identification unit 12L in a case of L2/lower-level device/active. A target profile to be identified in FIG. 10A is D (unicast (unicast negotiation disable)/multicast, E2E) and T1 (multicast, E2E).

The identification unit 12L connects to a network in which communication between the communication devices 1 and 2 in the L2 is performed (step S501).

The identification unit 12L determines whether or not the time synchronization signal transmitted from the lower-level device to the upper-level device via the communication interface 11 is received (step S502).

In a case of determining that the time synchronization signal transmitted from the lower-level device to the upper-level device is received (step S502: Yes), the identification unit 12L proceeds to processing in a case of L2/lower-level device/passive described with reference to FIG. 9A.

In a case of determining that the time synchronization signal is not received from the lower-level device (step S502: No), the identification unit 12L determines whether or not the profile used by the lower-level device is T1 (step S503). Specifically, the identification unit 12L makes the signal transmission unit 13 transmit the Announce and the Sync message (first time synchronization signal) to the multicast address at transmission intervals less than one second and determines whether or not a Delay req message is received from the lower-level device, in response to this.

In a case of determining that the Delay req message is received from the lower-level device (step S503: Yes), the identification unit 12L determines that the profile used by the lower-level device is T1 (step S504), and ends the processing.

In a case of determining that the Delay req message is not received from the lower-level device (step S503: No), the identification unit 12L determines whether or not the profile used by the lower-level device is D (multicast) (step S505). Specifically, the identification unit 12L makes the signal transmission unit 13 transmit the Announce and the Sync message (first time synchronization signal) to the multicast address at transmission intervals less than one second and determines whether or not a Delay req message is received from the lower-level device, in response to this.

In a case of determining that the Delay req message is received from the lower-level device (step S505: Yes), the identification unit 12L identifies that the profile used by the lower-level device is D (multicast, E2E) (step S506), and ends the processing.

In a case of determining that the Delay req message is not received from the lower-level device (step S505: No), the identification unit 12L identifies that the profile used by the lower-level device is D (unicast, unicast negotiation disable, E2E) (step S507), and ends the processing.

### <In a Case of L3/Lower-Level Device/Active>

FIG. 10B is a flowchart illustrating an example of an operation of the identification unit 12L in a case of L3/lower-level device/active. A target profile to be identified in FIG. 10B is D (unicast (unicast negotiation disable)/multicast, E2E) and S (unicast (unicast negotiation disable)/multicast, E2E).

The identification unit 12L connects to a network in which communication between the communication devices 1 and 2 in the L3 is performed (step S601).

The identification unit 12L determines whether or not the time synchronization signal transmitted from the lower-level device to the upper-level device via the communication interface 11 is received (step S602).

In a case of determining that the time synchronization signal transmitted from the lower-level device to the upper-level device is received (step S602: Yes), the identification unit 12L proceeds to processing in a case of L3/lower-level device/passive described with reference to FIG. 9B.

In a case of determining that the time synchronization signal transmitted from the lower-level device to the upper-level device is not received (step S602: No), the identification unit 12L determines whether or not the profile used by the lower-level device is S (multicast) Specifically, the identification unit 12L makes the signal transmission unit 13 transmit the Management message for requesting to set a parameter to the multicast address and determines whether or not the setting request is accepted. More specifically, the identification unit 12L makes the signal transmission unit 13 transmit the Management message (first time synchronization signal) of which actionField is COMMAND and TLV is Synchronization Metadata TLV to the multicast address. Then, the identification unit 12L determines whether or not the Management message of which actionField is ACKNOWLEDGE and TLV is Synchronization Metadata TLV is received from the lower-level device.

In a case of determining that the Management message of which actionField is ACKNOWLEDGE and TLV is Synchronization Metadata TLV is received from the lower-level device (step S603: Yes), the identification unit 12L identifies that the profile used by the lower-level device is S (multicast, E2E) (step S604), and ends the processing.

In a case of determining that the Management message of which actionField is ACKNOWLEDGE and TLV is Synchronization Metadata TLV is not received from the lower-level device (step S603: No), the identification unit 12L determines whether or not the profile used by the lower-level device is S (unicast) (step S605). Specifically, the identification unit 12L makes the signal transmission unit 13 transmit the Management message for requesting to set a parameter to the unicast address and determines whether or not the setting request is accepted. More specifically, the identification unit 12L makes the signal transmission unit 13 transmit the Management message (first time synchronization signal) of which actionField is COMMAND and TLV is Synchronization Metadata TLV to the lower-level device (communication device 2). Then, the identification unit 12L determines whether or not a Management message (second time synchronization signal) of which actionField is ACKNOWLEDGE and TLV is Synchronization Metadata TLV is received from the lower-level device

In a case of determining that the Management message of which actionField is ACKNOWLEDGE and TLV is Synchronization Metadata TLV is received from the lower-level device (step S605: Yes), the identification unit 12L identifies that the profile used by the lower-level device is S (unicast, unicast negotiation disable, E2E) (step S606), and ends the processing.

In a case of determining that the Management message of which actionField is ACKNOWLEDGE and TLV is Synchronization Metadata TLV is not received from the lower-level device (step S605: No), the identification unit 12L determines whether or not the profile used by the lower-level device is D (multicast) (step S607). Specifically, the identification unit 12L makes the signal transmission unit 13 transmit the Announce and the Sync (first time synchronization signal) to the unicast address and determines whether or not a Delay req (second time synchronization signal) is received, in response to this.

In a case of determining that the Delay req is received (step S607: Yes), the identification unit 12L identifies that the profile used by the lower-level device is D (multicast, E2E) (step S608), and ends the processing.

In a case of determining that the Delay req is not received (step S607: No), the identification unit 12L identifies that the profile used by the lower-level device is D (unicast, unicast negotiation disable, E2E) (step S609), and ends the processing.

### <In a Case of L2/Upper-Level Device/Active>

FIG. 10C is a flowchart illustrating an example of an operation of the identification unit 12U in a case of L2/upper-level device/active. A target profile to be identified in FIG. 10C is D (unicast, unicast negotiation enable, E2E).

The identification unit 12U connects to a network in which communication between the communication devices 1 and 2 in the L2 is performed (step S701).

The identification unit 12U determines whether or not the time synchronization signal transmitted from the upper-level device to the lower-level device via the communication interface 11 is received (step S702).

In a case of determining that the time synchronization signal transmitted from the upper-level device to the lower-level device is received (step S702: Yes), the identification unit 12U proceeds to processing in a case of L2/upper-level device/passive described with reference to FIG. 9C.

In a case of determining that the time synchronization signal transmitted from the upper-level device to the lower-level device is not received (step S702: No), the identification unit 12U determines that the profile used by the upper-level device is D (unicast, unicast negotiation enable, E2E) (step S703), and ends the processing.

### <In a Case of L3/Upper-Level Device/Active>

FIG. 10D is a flowchart illustrating an example of an operation of the identification unit 12U in a case of L3/upper-level device/active. A target profile to be identified in FIG. 10D is D (unicast, unicast negotiation enable, E2E) and T2 (unicast, unicast negotiation enable, E2E).

The identification unit 12U connects to a network in which communication between the communication devices 1 and 2 in the L3 is performed (step S801).

The identification unit 12U determines whether or not the time synchronization signal transmitted from the upper-level device to the lower-level device via the communication interface 11 is received (step S802).

In a case of determining that the time synchronization signal transmitted from the upper-level device to the lower-level device is received (step S802: Yes), the identification unit 12U proceeds to processing in a case of L3/upper-level device/passive described with reference to FIG. 9D.

In a case of determining that the time synchronization signal transmitted from the upper-level device to the lower-level device is not received (step S802: No), the identification unit 12U determines that the profile used by the upper-level device is D (unicast, unicast negotiation enable, E2E) or T2 (step S803), and ends the processing.

Note that, in FIGS. 9A to 10D, a case where the identification device 10 passively acquires the time synchronization signal from the communication devices 1 and 2 (receive time synchronization signal transmitted from communication devices 1 and 2, with no action from identification device 10) and a case where the identification device 10 actively acquires the time synchronization signal from the communication devices 1 and 2 (identification device 10 transmits time synchronization signal (first time synchronization signal) and time synchronization signal (second time synchronization signal) transmitted from communication devices 1 and 2 in response to time synchronization signal is received) are separately described. However, the present disclosure is not limited to this.

The identification device 10 may combine passive acquisition of the time synchronization signal and active acquisition of the time synchronization signal. For example, in a case where the identification device 10 does not receive the time synchronization signal for a predetermined time or more for some reason, the passive acquisition of the time synchronization signal may be switched to the active acquisition of the time synchronization signal. That is, in a case where the identification device 10 does not receive the time synchronization signal from the communication devices 1 and 2 when passively acquiring the time synchronization signal, the identification device 10 may transmit the time synchronization signal (first time synchronization signal) to the communication devices 1 and 2, receive the time synchronization signal (second time synchronization signal) transmitted from the communication devices 1 and 2 in response to the time synchronization signal, and identify the profile used by the communication devices 1 and 2, on the basis of information included in the received time synchronization signal.

In this way, the identification device 10 according to the present embodiment includes the identification unit 12 that identifies the profile used by the communication devices 1 and 2, on the basis of the information regarding the transmission and the reception of the time synchronization signal in accordance with the single profile among the plurality of profiles and the time synchronization method, included in the time synchronization signal acquired from the communication devices 1 and 2.

The information regarding the transmission and the reception of the time synchronization signal in accordance with the single profile and the time synchronization method is information that is constantly included in the time synchronization signal transmitted and received for the time synchronization between the communication devices 1 and 2. By using such information, according to the identification device 10 according to the present embodiment, it is possible to identify the profile used by the communication devices 1 and 2, regardless of whether or not the device is mounted.

### Second Embodiment

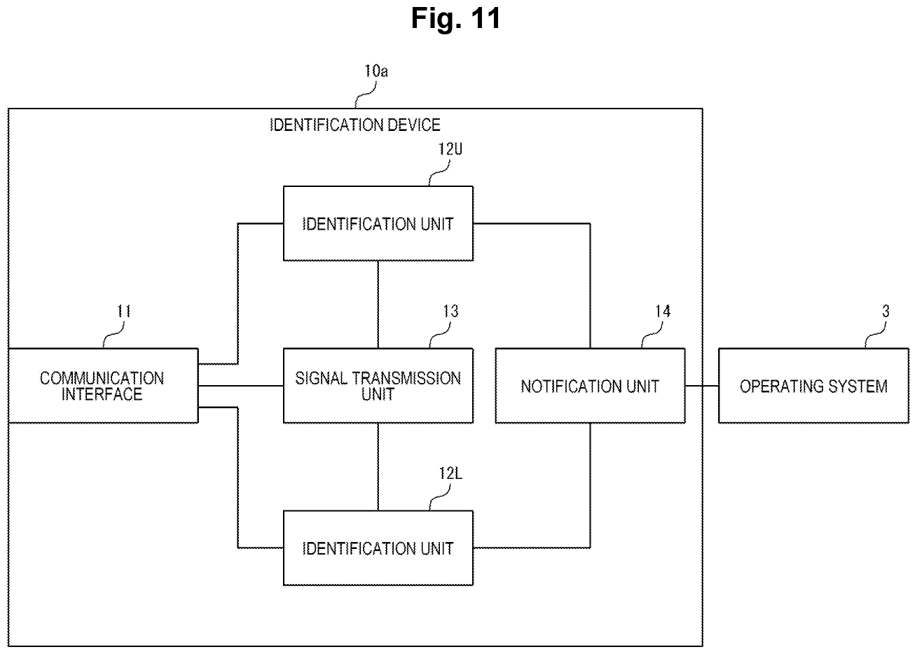

FIG. 11 is a diagram illustrating a configuration example of an identification device 10a according to a second embodiment of the present disclosure. In FIG. 11, components similar to those of FIG. 3A are denoted by the same reference signs, and description thereof will be omitted.

As illustrated in FIG. 11, the identification device 10a according to the present embodiment includes a communication interface 11, an identification unit 12U, an identification unit 12L, a signal transmission unit 13, and a notification unit 14. The identification device 10a according to the present embodiment is different from the identification device 10 according to the first embodiment in that the notification unit 14 is added.

The notification unit 14 receives an input of an identification result of profiles used by communication devices 1 and 2 by the identification units 12U and 12L. The notification unit 14 notifies outside of the identification result of the profiles used by the communication devices 1 and 2 by the identification units 12U and 12L. For example, the notification unit 14 notifies an operating system 3 that manages the identification device 10a of the identification result of the profiles used by the communication devices 1 and 2, by the identification units 12U and 12L. Furthermore, for example, the notification unit 14 may notify the identification result of the profile used by the communication devices 1 and 2, by display on a display device included in the identification device 10a or on a display device wiredly or wirelessly connected to the identification device 10a. Furthermore, for example, the notification unit 14 may notify the identification result of the profile used by the communication devices 1 and 2, by sound output.

Note that, in FIG. 11, an example is illustrated in which the notification unit 14 is added to the identification device 10 illustrated in FIG. 3A. However, the present disclosure is not limited to this. The notification unit 14 may be added to the identification device 10 illustrated in FIG. 3B or the identification device 10 illustrated in FIG. 3C.

According to the identification device 10a according to the present embodiment, the identification result of the profile used by the communication devices 1 and 2 can be notified outside.

### Third Embodiment

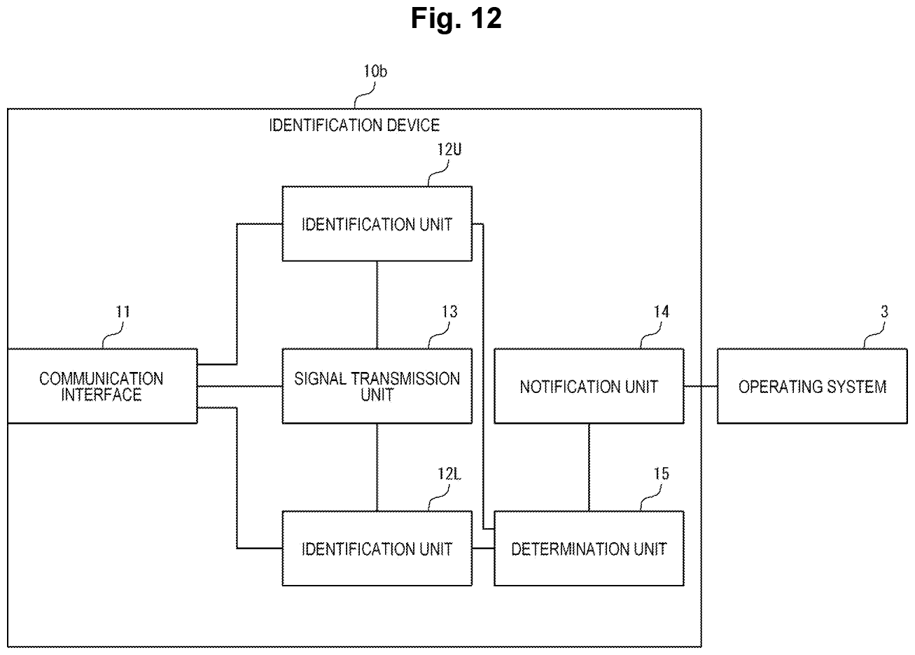

FIG. 12 is a diagram illustrating a configuration example of an identification device 10b according to a third embodiment of the present disclosure. In FIG. 12, components similar to those of FIG. 11 are denoted by the same reference signs, and description thereof will be omitted.

As illustrated in FIG. 12, the identification device 10b according to the present embodiment includes a communication interface 11, an identification unit 12U, an identification unit 12L, a signal transmission unit 13, a notification unit 14, and a determination unit 15. The identification device 10b according to the present embodiment is different from the identification device 10a according to the second embodiment in that the determination unit 15 is added.

The determination unit 15 receives an input of an identification result of profiles used by communication devices 1 and 2 by the identification units 12U and 12L. The determination unit 15 determines whether or not a profile identified to be used by the communication device 1 by the identification unit 12U matches a profile identified to be used by the communication device 2 by the identification unit 12L. The determination unit 15 outputs a determination result to the notification unit 14. As a result, the determination result by the determination unit 15 is notified to the outside (for example, operating system 3).

According to the identification device 10b according to the present embodiment, in a case where the profiles used by the communication devices 1 and 2 do not match, it is possible to notify the mismatch to the outside.

Note that, in FIG. 12, an example is illustrated in which the determination unit 15 is added to the identification device 10a illustrated in FIG. 11 (notification unit 14 and determination unit 15 are added to identification device 10 illustrated in FIG. 3A). However, the present disclosure is not limited to this. The notification unit 14 and the determination unit 15 may be added to the identification device 10 illustrated in FIG. 3B or the identification device 10 illustrated in FIG. 3C.

Furthermore, in FIG. 12, an example has been described in which the determination unit 15 determines whether or not the profile identified to be used by the communication device 1 matches the profile identified to be used by the communication device 2. However, the present disclosure is not limited to this. For example, the identification units 12U and 12L may continuously identify the profiles used by the communication devices 1 and 2, and the determination unit 15 may determine whether or not the profile used by the communication device 1 changes or the profile used by the communication device 2 changes. That is, the determination unit 15 may determine whether or not the profile used by the communication device 1 changes, on the basis of a past profile of the communication device 1 and a current profile of the communication device 1 identified by the identification unit 12U. Furthermore, the determination unit 15 may determine whether or not the profile used by the communication device 2 changes, on the basis of a past profile of the communication device 2 and a current profile of the communication device 2 identified by the identification unit 12L. In this way, in a case where the profiles used by the communication devices 1 and 2 are changed or a profile error occurs due to a soft error of the device by changing setting in the communication devices 1 and 2 during operation, it is possible to detect the change in the profiles used by the communication devices 1 and 2.

### Fourth Embodiment

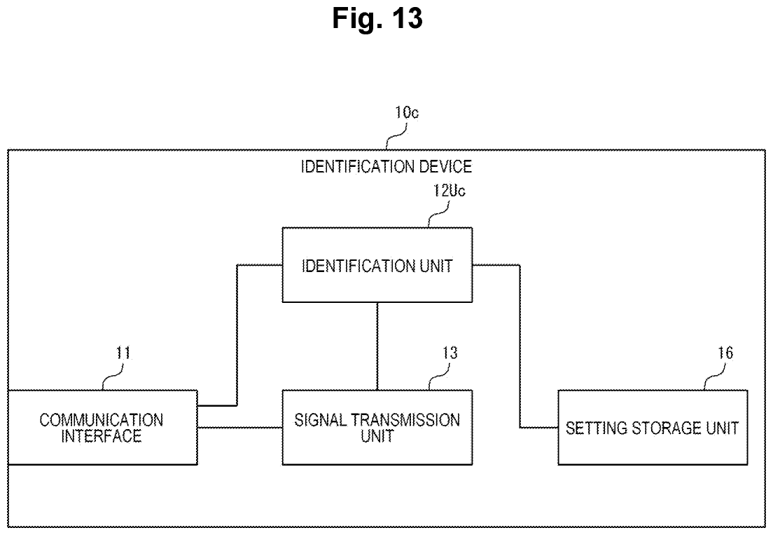

FIG. 13 is a diagram illustrating a configuration example of an identification device 10c according to a fourth embodiment of the present disclosure. In FIG. 13, components similar to those of FIG. 3B are denoted by the same reference signs, and description thereof will be omitted.

As illustrated in FIG. 13, the identification device 10c according to the present embodiment includes a communication interface 11, an identification unit 12Uc, a signal transmission unit 13, and a setting storage unit 16. The identification device 10c according to the present embodiment is different from the identification device 10 illustrated in FIG. 3B in that the setting storage unit 16 is added and the identification unit 12U is changed to the identification unit 12Uc.

The setting storage unit 16 stores settings necessary for a communication device 2 for performing time synchronization by communication devices 1 and 2, for each of a plurality of profiles to be candidates used when the communication devices 1 and 2 perform the time synchronization. The setting to the communication device 2 includes, for example, a message transmission cycle, a Domain number, a Priority, or the like.

The identification unit 12Uc identifies a profile used by the communication device 1, similarly to the identification unit 12U. The identification unit 12Uc reads setting corresponding to the identified profile from the setting storage unit 16 and sets the setting to the communication device 2. In this way, the identification unit 12a instructs the setting in accordance with the profile identified to be used by the communication device 1 (first communication device) to the communication device 2 (second communication device).

In this way, the setting in accordance with the identified profile is automatically performed on an opposing communication device. Therefore, when a device is newly provided or replaced, it is possible to suppress an increase in a work load for identifying a profile to be used and performing setting corresponding to the identified profile.

Note that, in FIG. 13, an example has been described in which the identification device 10c has a configuration, in which the identification unit 12U is changed to the identification unit 12Uc and the setting storage unit 16 is added, as compared with the identification device 10 illustrated in FIG. 3B. However, the present disclosure is not limited to this.

For example, the identification device 10c may have a configuration in which the identification unit 12L is changed to an identification unit 12Lc and the setting storage unit 16 is added, as compared with the identification device 10 illustrated in FIG. 3C. In this case, the setting storage unit 16 stores settings necessary for the communication device 1 for performing time synchronization by communication devices 1 and 2, for each of a plurality of profiles to be candidates used when the communication devices 1 and 2 perform the time synchronization. The identification unit 12L reads the setting of the communication device 1 corresponding to the profile identified to be used by the communication device 2 from the setting storage unit 16 and instructs the read setting to the communication device 1.

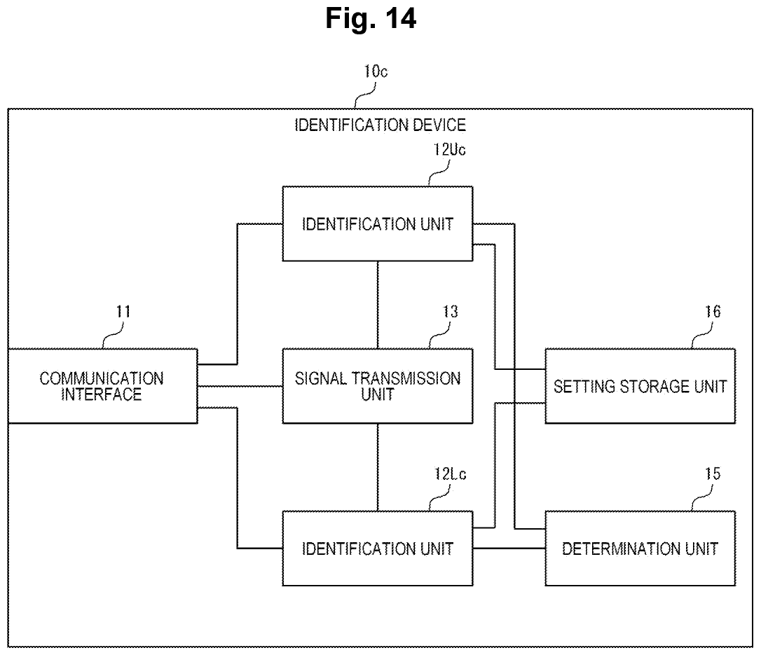

Furthermore, as illustrated in FIG. 14, the identification device 10c may include the communication interface 11, the identification unit 12Uc, the identification unit 12Lc, the signal transmission unit 13, the determination unit 15, and the setting storage unit 16.

It is assumed that the determination unit 15 determine that the profile identified to be used by the communication device 2 does not match. In this case, for example, when the identification unit 12Uc determines that the profile identified to be used by the communication device 1 is correct, the identification unit 12Uc reads setting of the communication device 2 corresponding to the profile identified to be used by the communication device 1 from the setting storage unit 16 and sets the setting to the communication device 2. Furthermore, when the identification unit 12Lc determines that the profile identified to be used by the communication device 2 is correct, the identification unit 12Lc reads the setting of the communication device 1 corresponding to the profile identified to be used by the communication device 2 from the setting storage unit 16 and sets the setting to the communication device 1.

Note that, in FIGS. 13 and 14, an example has been described in which the identification device 10c includes the setting storage unit 16 that stores the setting necessary for performing the time synchronization by the communication devices 1 and 2. However, the present disclosure is not limited to this. The settings necessary for performing the time synchronization by the communication devices 1 and 2 may be stored in an external memory that can be connected to the identification device 10c. Furthermore, the settings necessary for performing the time synchronization by the communication devices 1 and 2 may be stored in an external device such as a server device connected to the identification device 10c via a network.

Next, a hardware configuration of the identification devices 10, 10a, 10b, and 10c according to the present disclosure will be described.

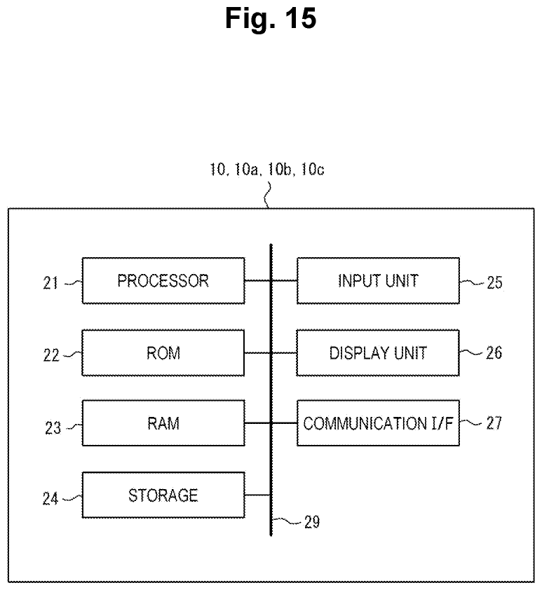

FIG. 15 is a diagram illustrating an example of the hardware configuration of the identification devices 10, 10a, 10b, and 10c according to the present disclosure. In FIG. 15, an example of the hardware configuration of the identification devices 10, 10a, 10b, and 10c in a case where the identification devices 10, 10a, 10b, and 10c are configured by a computer that can executes a program instruction is illustrated. Here, the computer may be a general-purpose computer, a dedicated computer, a workstation, a personal computer (PC), an electronic notepad, or the like. The program instructions may be program codes, code segments, or the like for executing a required task.

As illustrated in FIG. 15, the identification devices 10, 10a, 10b, and 10c include a processor 21, a read only memory (ROM) 22, a random access memory (RAM) 23, a storage 24, an input unit 25, a display unit 26, and a communication interface (I/F) 27. The components are communicably connected with each other via a bus 29. Specifically, the processor 21 is a central processing unit (CPU), a micro processing unit (MPU), a graphics processing unit (GPU), a digital signal processor (DSP), a system on a chip (SoC), or the like, and may be configured by a plurality of processors of the same type or different types.

The processor 21 is a control unit that executes control of the components and various types of arithmetic processing. That is, the processor 21 reads a program from the ROM 22 or the storage 24 and executes the program using the RAM 23 as a work area. The processor 21 executes the control of the components and various types of the arithmetic processing in accordance with a program stored in the ROM 22 or the storage 24. In the present embodiment, the ROM 22 or the storage 24 stores a program for causing the computer to operate as the identification devices 10, 10a, 10b, and 10c according to the present disclosure. The program is read and executed by the processor 21, whereby each of the components of the identification devices 10, 10a, 10b, and 10c described above is implemented.

The program may be provided in a form in which the program is stored in a non-transitory storage medium, such as a compact disk read only memory (CD-ROM), a digital versatile disk read only memory (DVD-ROM), or a universal serial bus (USB) memory. Furthermore, the program may be downloaded from an external device via a network.

The ROM 22 stores various programs and various types of data. The RAM 23 as a work area temporarily stores programs or data. The storage 24 includes a hard disk drive (HDD) or a solid state drive (SSD) and stores various programs including an operating system and various types of data.

The input unit 25 includes a pointing device such as a mouse and a keyboard, and is used to perform various inputs.

The display unit 26 is, for example, a liquid crystal display, and displays various types of information. The display unit 26 may function as the input unit 25 by employing a touchscreen system.

The communication interface 27 is an interface for communicating with another device (for example, communication devices 1 and 2).

A computer can be suitably used to function as each unit of the identification devices 10, 10a, 10b, and 10c described above. Such a computer can be implemented by storing a program in which processing content for implementing a function of each unit of the identification devices 10, 10a, 10b, and 10c is written in a storage unit of the computer and causing a processor of the computer to read and execute the program. That is, the program can cause the computer to function as the identification devices 10, 10a, 10b, and 10c described above. Furthermore, the program can also be recorded in a non-transitory storage medium. Furthermore, the program can be provided via a network.

Regarding the above embodiments, the following supplementary notes are further disclosed.

### [Supplementary Note 1]

An identification device that is connected to a first communication device and a second communication device that perform time synchronization, by transmission and reception of a time synchronization signal in accordance with a single profile among a plurality of profiles and identifies a profile used by at least the first communication device, of the first communication device and the second communication device, the identification device including:
a memory; and
a control unit connected to the memory, in which
the control unit
identifies the profile used by the first communication device, on the basis of information regarding the transmission and the reception of the time synchronization signal in accordance with the single profile among the plurality of profiles and a method of the time synchronization, included in the time synchronization signal acquired from the first communication device.

### [Supplementary Note 2]

The identification device according to supplementary note 1, in which
the control unit receives the time synchronization signal transmitted from the first communication device to the second communication device and identifies the profile used by the first communication device, on the basis of information included in the received time synchronization signal.

### [Supplementary Note 3]

The identification device according to supplementary note 1, in which
the control unit transmits a first time synchronization signal to the first communication device, receives a second time synchronization signal transmitted from the first communication device in response to the first time synchronization signal, and identifies the profile used by the first communication device, on the basis of information included in the received second time synchronization signal.

### [Supplementary Note 4]

The identification device according to supplementary note 1, in which
the control unit
further identifies a profile used by the second communication device, on the basis of information regarding setting for performing the time synchronization in accordance with the single profile among the plurality of profiles, included in the time synchronization signal acquired from the second communication device, and
determines whether or not a profile identified to be used by the first communication device matches a profile identified to be used by the second communication device.

### [Supplementary Note 5]

The identification device according to supplementary note 4, in which
the control unit notifies outside of a determination result of the determination unit.

### [Supplementary Note 6]

The identification device according to supplementary note 1, in which
the control unit notifies outside of a profile identified for at least one of the first communication device and the second communication device.

### [Supplementary Note 7]

The identification device according to supplementary note 1, in which
the control unit instructs the second communication device to perform setting in accordance with the profile identified to be used by the first communication device.

### [Supplementary Note 8]

The identification device according to supplementary note 4, in which
in a case where it is determined that the profile identified to be used by the first communication device does not match the profile identified to be used by the second communication device, the control unit instructs another communication device of the first communication device and the second communication device, to perform setting in accordance with the profile identified to be used by one communication device, of the first communication device and the second communication device.

### [Supplementary Note 9]

An identification method by an identification device that is connected to a first communication device and a second communication device that perform time synchronization, by transmission and reception of a time synchronization signal in accordance with a single profile among a plurality of profiles and identifies a profile used by at least the first communication device of the first communication device and the second communication device, the identification method including:
acquiring the time synchronization signal from the first communication device; and
identifying the profile used by the first communication device, on the basis of information regarding the transmission and the reception of the time synchronization signal in accordance with the single profile among the plurality of profiles and a method of the time synchronization, included in the acquired time synchronization signal.

Although the above embodiments have been described as typical examples, it is obvious to those skilled in the art that many modifications and substitutions can be made within the spirit and scope of the present disclosure. Thus, it should not be understood that the present invention is limited by the embodiments described above, and various modifications or changes can be made without departing from the scope of the claims. For example, a plurality of configuration blocks described in the configuration diagram of the embodiments can be combined into one, or one configuration block can be divided.

### REFERENCE SIGNS LIST

1, 2 communication device
10, 10a, 10b, 10c identification device
11 communication interface
12U, 12L, 12Uc, 12Lc identification unit
13 time synchronization unit
14 notification unit
15 determination unit
16 setting storage unit
21 processor
22 ROM
23 RAM
24 storage
25 input unit
26 display unit
27 communication I/F
29 bus

1. An identification device comprising a processor configured to execute operations comprising:
connecting to a first communication device and a second communication device that respectively perform time synchronization, by transmission and reception of a time synchronization signal in accordance with a single profile among a plurality of profiles of the first communication device and the second communication device; and
identifying a profile used by the first communication device, on the basis of information regarding the transmission and the reception of the time synchronization signal in accordance with the single profile among the plurality of profiles and a method of the time synchronization, included in the time synchronization signal acquired from the first communication device.

2. The identification device according to claim 1, wherein
the identifying further comprises:
receiving the time synchronization signal transmitted from the first communication device to the second communication device, and
identifying the profile used by the first communication device, on the basis of information included in the received time synchronization signal.

3. The identification device according to claim 1, wherein
the identifying further comprises:
transmitting a first time synchronization signal to the first communication device,
receiving a second time synchronization signal transmitted from the first communication device in response to the first time synchronization signal, and
identifying the profile used by the first communication device, on the basis of information included in the received second time synchronization signal.

4. The identification device according to claim 1, wherein
the identifying further comprises identifying a profile used by the second communication device, on the basis of information regarding setting for performing the time synchronization in accordance with the single profile among the plurality of profiles, included in the time synchronization signal acquired from the second communication device, and
the processor further configured to execute operations comprising:
determining whether a first identified profile to be used by the first communication device matches a second identified profile identified to be used by the second communication device.

5. The identification device according to claim 4, the processor further configured to execute operations comprising:
notifying outside of a determination result of the determining.

6. The identification device according to claim 1, the processor further configured to execute operations comprising:
notifying outside of a profile identified by the identifying for at least one of the first communication device and the second communication device.

7. The identification device according to claim 1, wherein
the identifying further comprises identifying the second communication device to perform setting in accordance with the profile identified to be used by the first communication device.

8. The identification device according to claim 4, wherein
the profile identified to be used by the first communication device as determined in the determining does not match the profile as identified by identifying to be used by the second communication device, the identifying further comprises instructing another communication device of the first communication device and the second communication device, to perform setting in accordance with the profile identified to be used by one communication device, of the first communication device and the second communication device.

9. A method for identifying a profile, comprising:
connecting to a first communication device and a second communication device that respectively perform time synchronization, by transmission and reception of a time synchronization signal in accordance with a single profile among a plurality of profiles;
identifying a profile used by at least the first communication device of the first communication device and the second communication device;
acquiring the time synchronization signal from the first communication device; and
identifying a profile used by the first communication device, on the basis of information regarding the transmission and the reception of the time synchronization signal in accordance with the single profile among the plurality of profiles and a method of the time synchronization, included in the acquired time synchronization signal.
